(19) United States
(12) Patent Application Publication
(10) Pub. No.: US 2014/0051349 A1
(43) Pub. Date: Feb. 20, 2014

(54) RADIO COMMUNICATION SYSTEM, RADIO TERMINAL, CONTROL METHOD OF RADIO TERMINAL AND CONTROL PROGRAM OF RADIO TERMINAL

(71) Applicants: Takashi Watanabe, Nara (JP); Yoshio Horiike, Osaka (JP); Masahiro Yamamoto, Nara (JP)

(72) Inventors: Takashi Watanabe, Nara (JP); Yoshio Horiike, Osaka (JP); Masahiro Yamamoto, Nara (JP)

(73) Assignee: PANASONIC CORPORATION, Kadoma-shi, Osaka (JP)

(21) Appl. No.: 14/114,120

(22) PCT Filed: Apr. 26, 2012
(86) PCT No.: PCT/JP2012/002871

§ 371 Date: Oct. 25, 2013

(30) Foreign Application Priority Data
Apr. 28, 2011 (JP) 2011-101068
Apr. 28, 2011 (JP) 2011-101075

(51) Int. Cl. H04B 7/155

(52) U.S. Cl. CPC H04B 7/15528
USPC 455/9

(57) ABSTRACT

In a radio communication system of the present invention, a radio master terminal and a radio relay terminal are configured to transmit beacon signals each containing relay stage number information which is information indicating the number of radio relay terminals via which communication with the radio master terminal is performed, and the radio terminal which newly participates in the radio communication system includes: a reception level measuring section for measuring reception levels of received beacon signals; a relay stage number analyzing section for obtaining relay stage number information from each of the received beacon signals; and an upper radio terminal deciding section for deciding as a connection target a radio terminal which is a transmission source of the beacon signal in which the measured reception level is determined as equal to or higher than a specified value, and the relay stage number is smallest based on the obtained relay stage number information.

### TECHNICAL FIELD

The present invention relates to a radio (wireless) communication system comprising at least a radio master (access point) terminal, a radio relay terminal, and a radio slave terminal. Particularly, the present invention relates to a radio communication system configured in such a manner that the radio master terminal and the radio relay terminal are able to transmit beacon signals, and another radio relay terminal and the radio slave terminal are able to receive the beacon signal transmitted from the radio master terminal or the radio relay terminal and synchronize a clock of each of the radio relay terminal and the radio slave terminal with a clock of the radio terminal which is a transmission source.

### BACKGROUND ART

In a radio communication system in which a radio master terminal is able to perform radio communication with many radio slave terminals, in a case where the radio slave terminals are operative using built-in batteries as power supplies, it is necessary to suppress electric power consumption in the radio slave terminals, to reduce a frequency of battery change. Typically, in order to suppress electric power consumption, the radio slave terminal is configured to intermittently await reception of a radio signal from the radio master terminal or the radio relay terminal, i.e., perform intermittent reception awaiting. As a radio communication system in which radio slave terminal performs intermittent reception awaiting, there is a radio communication system in which the radio master terminal transmits a beacon signal regularly and the radio slave terminal receives the beacon signal regularly. In this radio communication system, the following synchronization method is used. Based on the received beacon, the radio slave terminal synchronizes a clock of itself with a clock of the radio master terminal, and awaits reception of polling data from the radio master terminal at a specified timing. Such a synchronization method is typically effective in reducing electric power consumption in the radio slave terminal.

In the radio communication system which employs such a synchronization method, in some cases, direct communication between the radio master terminal and the radio slave terminal cannot be performed depending on a location where the radio slave terminal is placed. In such cases, a radio relay terminal which relay-transmits a radio signal is used. One radio relay terminal, or two or more radio relay terminals are placed between the radio master terminal and a certain radio slave terminal.

In the above radio communication system including the radio relay terminal(s) which relay-transmit(s) the radio signal between the radio master terminal and the radio slave terminal, a management method of a communication route used to perform communication between the radio master terminal and the radio slave terminal via the radio relay terminal(s) is important. As an example of the management method of the communication route in the radio communication system, there is a radio network relay management method disclosed in Patent Literature 1. In the radio network relay management method disclosed in Patent Literature 1, there is provided a management device for managing a plurality of communication routes including a relay route connecting radio terminals, and a communication route which satisfies desired communication requirements is selected from among the plurality of communication routes managed by the management device. More specifically, each radio terminal regularly transmits an electric (field) intensity measurement signal for measurement of an electric intensity level. When each radio terminal receives the electric intensity measurement signal transmitted from another radio terminal, it transmits reception level information to the management device via radio waves. The management device creates a relay route table representing a connection between the radio terminals based on the reception level transmitted from each radio terminal. Each radio terminal decides a communication route up to a communication other party with reference to the relay route table created by the management device.
Patent Literature 1: Japanese Laid-Open Patent Application Publication No. Hei. 11-168526

### SUMMARY OF THE INVENTION

### Technical Problem

However, the technique disclosed in Patent Literature 1 has drawbacks that it cannot construct a radio communication system which is highly reliable and is able to manage relay routes between the radio terminals, with a simple configuration without a locational constraint.

Specifically, in the radio network relay management method disclosed in Patent Literature 1, the following (1) to (3) problems associated with management of the relay routes exist. For this reason, when a radio terminal is newly incorporated into a radio network, the method cannot realize a radio communication system which is highly reliable with a simple configuration without a locational constraint.

(1) Because of a need for the management device for managing the relay routes, the system becomes complex and construction of the system is costly.

(2) Since the management device needs to obtain the reception level information from all of the radio terminals, a locational constraint that the management device must be placed in a location where it can be wirelessly connected to all of the radio terminals arise in construction of the system.

(3) All of the radio terminals need to regularly transmit the electric intensity measurement signals to another radio terminals. In addition, all of the radio terminals need to receive all of the electric intensity measurement signals from another radio terminals. This increases the number of times of transmission and reception of the signals communicated between the radio terminals to create the relay routes, and hence increases the electric power consumed in the radio terminals. Moreover, due to an increase in traffic, reliability of the system degrades.

The present invention has been made to solve the above mentioned problems, and an object of the present invention is to provide a radio communication system which is highly reliable with a simple configuration without a locational constraint, even when a radio terminal is newly incorporated into the radio communication system. Another object of the present invention is to provide a radio terminal, a control method of the radio terminal, and a control program of the radio terminal, which allow the radio terminal to newly participate in the radio communication system while ensuring a high reliability in the radio communication system with a simple configuration without a locational constraint.

### Solution to Problem

To solve the above mentioned problem, a radio communication system of the present invention comprises a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal; wherein the radio master terminal and the radio relay terminal are configured to transmit beacon signals each containing radio relay terminal number information which is information indicating the number of another radio relay terminals via which communication with the radio master terminal is performed; wherein the radio terminal which newly participates in the radio communication system includes: a measuring unit for measuring reception levels of the received beacon signals; an information obtaining unit for obtaining the radio relay terminal number information from each of the received beacon signals; and a deciding unit for deciding as a connection target a radio terminal which is a transmission source of the beacon signal in which the reception level measured by the measuring unit is determined as equal to or higher than a specified value, and the number of another radio relay terminals is smallest based on the radio relay terminal number information obtained by the information obtaining unit.

The above and further objects, features and advantages of the present invention will more fully be apparent from the following detailed description of preferred embodiments with accompanying drawings.

### Advantageous Effects of the Invention

As described above, the present invention can achieve advantages that it is possible to provide a highly reliable radio communication system, with a simple configuration without a locational constraint.

### BRIEF DESCRIPTION OF THE DRAWINGS

FIG. 1 is view showing an exemplary communication area configuration in a radio (wireless) communication system according to Embodiment 1 of the present invention.

FIG. 2 is a view showing exemplary hierarchal (tree) structures of the radio communication system according to Embodiment 1 of the present invention.

FIG. 3 is a view showing an exemplary frame configuration of a beacon signal transmitted between radio terminals in the radio communication system according to Embodiment 1 of the present invention.

FIG. 4 is a block diagram showing an exemplary configuration of major components of a radio terminal serving as a radio master terminal according to Embodiment 1 of the present invention.

FIG. 5 is a block diagram showing an exemplary configuration of major components of a radio terminal serving as a radio relay terminal according to Embodiment 1 of the present invention.

FIG. 6 is a block diagram showing an exemplary configuration of major components of a radio terminal serving as a radio slave terminal according to Embodiment 1 of the present invention.

FIG. 7 is a block diagram showing an exemplary configuration of a beacon reception section of the radio terminal according to Embodiment 1 of the present invention.

FIG. 8 is a flowchart showing an exemplary connection target deciding process performed by the radio relay terminal and the radio slave terminal according to Embodiment 1 of the present invention.

FIG. 9 is a flowchart showing an exemplary connection target deciding process performed by the radio relay terminal and the radio slave terminal according to Embodiment 1 of the present invention.

FIG. 10 is a view showing an exemplary slot configuration managed by the radio terminal according to Embodiment 1 of the present invention.

FIG. 11 is a view showing an exemplary link connection slot included in a slot (base slot) of FIG. 10.

FIG. 12 is a view showing an exemplary positional relationship between the time slots (base slots) of FIG. 10, which are managed by the radio terminals.

FIG. 13 is a view showing an exemplary positional relationship between the time slots (base slots) of FIG. 10, which are managed by the radio terminals.

FIG. 14 is a view showing an exemplary signal format of the link connection signal transmitted between the radio terminals in the radio communication system according to Embodiment 1 of the present invention.

FIG. 15 is a view showing an exemplary frame configuration of repeated frames contained in the link connection signal of FIG. 14.

FIG. 16 is a view showing an exemplary signal format of a data communication signal transmitted and received between the radio terminals in the radio communication system according to Embodiment 1 of the present invention.

FIG. 17 is a view showing an exemplary frame configuration of a network layer frame contained in the data communication signal of FIG. 16.

FIG. 18 is a view showing an exemplary configuration of route information according to Embodiment 1 of the present invention.

FIG. 19 is a view showing a bit configuration of radio relay terminal information contained in the route information of FIG. 18.

FIG. 20 is a view showing a bit configuration of slot position information contained in the route information of FIG. 18.

FIG. 21 is a block diagram showing an exemplary configuration of major components of a beacon reception section included in the radio relay terminal or the radio slave terminal according to Embodiment 2 of the present invention.

FIG. 22 is a flowchart showing an exemplary new connection target deciding process executed in a lower device in the radio communication system according to Embodiment 2 of the present invention.

### DETAILED DESCRIPTION OF THE PREFERRED EMBODIMENTS

The present invention can provide the following aspects.

According to a first aspect of the present invention, there is provided a radio communication system comprising: a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal; wherein the radio master terminal and the radio relay terminal are configured to transmit beacon signals each containing radio relay terminal number information which is information indicating the number of another radio relay terminals via which communication with the radio master terminal is performed; wherein the radio terminal which newly participates in the radio communication system includes: a measuring unit for measuring reception levels of the received beacon signals; an information obtaining unit for obtaining the radio relay terminal number information from each of the received beacon signals; and a deciding unit for deciding as a connection target a radio terminal which is a transmission source of the beacon signal in which the reception level measured by the measuring unit is determined as equal to or higher than a specified value, and the number of another radio relay terminals is smallest based on the radio relay terminal number information obtained by the information obtaining unit.

The reception level is, for example, an electric (field) intensity level.

In accordance with the above configuration, the measuring unit included in the radio terminal which newly participates in the radio communication system of the present invention makes it possible to measure the reception level of each of the beacon signals received from the radio master terminal or the radio relay terminal constituting the radio communication system.

In addition, the information obtaining unit included in the radio terminal makes it possible to know the number of radio relay terminals of each of transmission sources of the beacon signals.

Furthermore, the deciding unit included in the radio terminal makes it possible to decide as the connection target the radio terminal which is the transmission source of the beacon signal in which the reception signal is equal to or higher than the specified value and the number of radio relay terminals is smallest.

Thus, it becomes possible to decide as the connection target another party which enables establishment of a route in which the number of radio relay terminals via which communication with the radio master terminal is performed is smallest, while ensuring that the reception level (electric intensity level) of the received beacon signal is equal to or higher than a specified value.

Thus, in the radio communication system of the present invention, the radio terminal itself, which newly participates in the radio communication system, can decide an appropriate connection target. Therefore, unlike the conventional technique, there is no need for a management device for managing the relay route, and hence the configuration can be simplified. In addition, unlike the conventional technique, since there is no need for the management device, a locational constraint, for example, a radio terminal can be placed only in a location where this radio terminal can be wirelessly connected to the management device, will not occur. Also, it is sufficient that the radio master terminal and the radio relay terminal transmit the beacon signals. That is, unlike the conventional technique, all of the radio terminals need not regularly transmit the electric (field) intensity measurement signals to another radio terminals. This makes it possible to prevent a situation in which the number of times the signals are transmitted and received between the radio terminals increases and hence electric power consumption in the radio terminals increases. As a result, it becomes possible to prevent a situation in which a traffic increases and a reliability of the system degrades.

Therefore, the radio communication system according to Embodiment 1 of the present invention can achieve an advantage that it is possible to provide a radio communication system which is highly reliable with a simple configuration without a locational constraint, when the radio terminal is newly incorporated into the radio communication system.

According to a second aspect of the present invention, in the radio communication system, the deciding unit decides as the connection target a radio terminal which is a transmission source of the beacon signal in which the reception level is highest, from among the beacon signals, when all of the reception levels of the beacon signals measured by the measuring unit are lower than the specified value.

According to a third aspect of the present invention, in the radio communication system, the specified value includes a first specified value decided considering a noise level under a general environment in which the radio communication system is constructed and a second specified value set greater than the first specified value; wherein the deciding unit determines whether or the reception level of the beacon signal is equal to or higher than the specified value by confirming whether or not the reception level of the beacon signal in which the number of another radio relay terminals is in a range of zero to a specified number or less is equal to or higher than the first specified value and confirming whether or not the reception level of the beacon signal in which the number of another radio relay terminals is greater than specified number is equal to or higher than the second specified value.

In accordance with the above described configuration, the specified value may be made different between a case where the number of the radio relay terminals via which communication with the radio master terminal is performed is in a range of zero to the specified number and a case where the number of radio relay terminals via which communication with the radio master terminal is performed is greater than the specified value. For example, by setting the second specified value greater than the first specified value, it becomes possible to prevent a degradation of a communication reliability due to an increase in the number of times of the communication which is caused by an increase in the number of radio relay terminals.

According to a fourth aspect of the present invention, in the radio communication system, the specified value includes a first specified value decided considering a noise level under a general environment in which the radio communication system is constructed and a second specified value set greater than the first specified value; wherein in a case where the radio terminal which newly participates in the radio communication system is the radio slave terminal, the deciding unit determines whether or not the reception level of the received beacon signal is equal to or higher than the first specified value; and wherein in a case where the radio terminal which newly participates in the radio communication system is the radio relay terminal, the deciding unit determines whether or not the reception level of the received beacon signal is equal to or higher than the second specified value.

According to a fifth aspect of the present invention, there is provided a radio communication system comprising: a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal; wherein the radio master terminal and the radio relay terminal are configured to transmit beacon signals each containing radio relay terminal number information which is information indicating the number of another radio relay terminals via which communication with the radio master terminal is performed; wherein the radio terminal which newly participates in the radio communication system includes: a measuring unit for measuring reception levels of the received beacon signals; an information obtaining unit for obtaining the radio relay terminal number information from each of the beacon signals; and a deciding unit for deciding the radio terminal as a connection target; wherein the deciding unit decides the radio master terminal as the radio terminal which is the connection target when there exists the beacon signal in which the number of another radio relay terminals is zero based on the radio relay terminal number information obtained by the information obtaining unit, and the reception level measured by the measuring unit is equal to or higher than the specified value; and when the number of another radio relay terminals is not zero, the deciding unit decides as the connection target the radio terminal which is a transmission source of the beacon signal in which the reception level measured by the measuring unit is equal to or higher than the specified value, and the number of another radio relay terminals is smallest based on the radio relay terminal number information obtained by the information obtaining unit.

In accordance with this configuration, the deciding unit is able to decide as the connection target for the radio terminal, for each of a case where the number of relay terminals in the beacon signal in which the reception level measured by the measuring unit is equal to or higher than the specified value, is zero and a case where the number of relay terminals in the beacon signal in which the reception level measured by the measuring unit is equal to or higher than the specified value, is not zero. In other words, the deciding unit is able to decide the connection target for the radio terminal which newly participates in the radio communication system, for each of the case where the connection target is the radio master terminal and the case where the connection target is not the radio master terminal.

Therefore, the specified value used to determine the reception level of the beacon signal can be made different between the case where it is decided whether or not the connection target is the radio master terminal and the case where it is decided whether or not the connection target is a radio terminal other than the radio master terminal, i.e., radio relay terminal in such a way that for example, the specified value corresponding to the latter case is greater than that corresponding to the former case. Therefore, it becomes possible to prevent a degradation of a communication reliability due to an increase in the number of times of the communication which is caused by an increase in the number of radio relay terminals.

Therefore, it becomes possible to provide a radio communication system which is highly reliable, with a simple configuration, even when the radio terminal is newly incorporated into the radio communication system.

According to a sixth aspect of the present invention, there is provided a radio communication system comprising: a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal; wherein a beacon signal is regularly transmitted from the radio terminal which is an upper device to the radio terminal which is a lower device; and wherein the radio terminal which is the lower device further includes: a reception level determiner unit for determining whether or not a reception level B is equal to or lower than a value derived by subtracting a specified level C from a reception level A; and a new connection target deciding unit for newly deciding as a connection target the radio terminal which is the upper device, when the reception level determiner unit determines that the reception level B is equal to or lower than the value derived by subtracting the specified level C from the reception level A, the reception level A being a reception level of the beacon signal received from the radio terminal which is the upper device decided as the connection target by the radio terminal which is the lower device, when the radio terminal which is the lower device newly participates in the radio communication system, the reception level B being a reception level of the beacon signal regularly received from the radio terminal which is the upper device, and the specified level C being a value set in a range within which a decrease in the reception level from the reception level A is allowed.

In accordance with this configuration, the reception level determiner unit included in the radio terminal enables, for example, the radio terminal which is the lower device to determine whether or not the reception level of the beacon signal regularly received from the radio terminal which is the upper device is lowered due to a change in electric waves surrounding this radio terminal. Especially, the reception level determiner unit is able to determine whether or not the lowered reception level is equal to or lower than the value derived by subtracting the specified level C from the reception level A. This makes it possible to determine whether or not the reception level of the beacon signal regularly received from the radio terminal which is the upper device is lowered from the value of the reception level A significantly beyond an allowable range.

In addition, the new connection target deciding unit included in the radio terminal makes it possible to newly decide as the connection target the radio terminal which is the upper device, in the case where the reception level of the beacon signal regularly received is lowered from the value of the reception level A significantly beyond the allowable range.

Because of the above configuration, in the radio communication system, it becomes possible to review the connection target only in the case where the reception level of the beacon signal regularly received does not satisfy a desired communication quality, without a need to frequently review the connection target depending on a fluctuation in the reception level of the beacon signal regularly received. Then, it becomes possible to newly decide the radio terminal which is the connection target and change a route up to the radio master terminal. Thus, unlike the conventional technique, all of the radio terminals need not regularly transmit the electric (field) intensity measurement signals to another radio relay terminals or receive the electric (field) intensity measurement signals transmitted from another radio relay terminals to change the relay route. That is, unlike the conventional technique, the number of times the signals are transmitted and received between the radio terminals to change the relay route does not increase, and as a result, it becomes possible to avoid a problem that a traffic increases or a problem that electric power consumption increases.

According to a seventh aspect of the present invention, in the radio communication system, when it is determined that the reception level B of the beacon signal regularly received has become equal to or lower than the value derived by subtracting the specified level C from the reception level A a specified number of times in succession, the new connection target deciding unit newly decides as the connection target the radio terminal which is the upper device.

In accordance with the above configuration, when it is determined that the reception level B has become equal to or lower than the value derived by subtracting the specified level C from the reception level A, the specified number of times in succession, the new connection target deciding unit can newly decide the radio terminal as the connection target. Therefore, in a case where the reception level B happens to be lowered from the value of the reception level A significantly beyond an allowable range, for a moment, deciding of the radio terminal as the connection target is not performed. This makes it possible to avoid a situation in which the connection target is reviewed frequently.

According to an eighth aspect of the present invention, in the radio communication system, when a ratio in which the reception level B of the beacon signal regularly transmitted has become equal to or lower than the value derived by subtracting the specified level C from the reception level A, within a specified period, exceeds a specified value, the new connection target deciding unit newly decides the radio terminal as the connection target.

In accordance with the above configuration, when it is determined that the ratio in which the reception level B which has become equal to or lower than the value derived by subtracting the specified level C from the reception level A, within the specified period, exceeds the specified value, the new connection target deciding unit can newly decide the radio terminal as the connection target. Therefore, in a case where the reception level B happens to be lowered from the value of the reception level A significantly beyond the allowable range, for a moment, deciding of the radio terminal as the connection target is not performed. This makes it possible to avoid a situation in which the connection target is reviewed frequently.

According to a ninth aspect of the present invention, in the radio communication system, the specified level C is a value set according to a value of the reception level A.

In accordance with this configuration, since the value of the specified level C can be set according to the value of the reception level A, an optimal value can be set as the specified level C, for each reception level A.

By the way, frequency of processing for newly deciding the connection target and a communication quality in the radio communication system are affected by the value of the specified value C. Since the optimal value of the specified level C can be set according to the value of the reception level A, it becomes possible to suppress the frequency of processing for newly deciding the radio terminal as the connection target, from becoming excess, and ensure the communication quality in the radio communication system.

According to a tenth aspect of the present invention, there is provided a radio terminal which newly participates in a radio communication system including: a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal; wherein the radio master terminal and the radio relay terminal are configured to transmit beacon signals each containing radio relay terminal number information which is information indicating the number of another radio relay terminals via which communication with the radio master terminal is performed; the radio terminal which newly participates in the radio communication system, comprising: a measuring unit for measuring reception levels of the received beacon signals; an information obtaining unit for obtaining the radio relay terminal number information from each of the beacon signals; and a deciding unit for deciding as a connection target the radio terminal which is a transmission source of the beacon signal in which the reception level measured by the measuring unit is equal to or higher than a specified value, and the number of another radio relay terminals is smallest based on the radio relay terminal number information obtained by the information obtaining unit.

The reception level is, for example, an electric (field) intensity level.

In accordance with this configuration, the measuring unit included in the radio terminal makes it possible to measure the reception level of each of the beacon signals received from the radio master terminal or the radio relay terminal constituting the radio communication system.

In addition, the information obtaining unit included in the radio terminal allows the radio terminal which newly participates in the radio communication system to know the number of radio relay terminals in each of the transmission sources of the beacon signals.

Furthermore, the deciding unit included in the radio terminal unit makes it possible to decide as the connection target the radio terminal which is the transmission source of the beacon signal in which the reception level is equal to higher than the specified value and the number of radio relay terminals is smallest.

Thus, it becomes possible to decide as the connection target another party which enables establishment of a route in which the number of radio relay terminals via which communication with the radio master terminal is performed is smallest, while ensuring that the reception level (electric intensity level) of the received beacon signal is equal to or higher than the specified value.

As described above, the radio terminal itself which newly participates in the radio communication system can decide an appropriate connection target. Therefore, unlike the conventional technique, there is no need for a management device for managing the relay route, and hence the configuration can be simplified. In addition, unlike the conventional technique, since there is no need for the management device, a locational constraint, for example, a radio terminal can be placed only in a location where this radio terminal can be wirelessly connected to the management device, will not occur. Also, it is sufficient that the radio master terminal and the radio relay terminal transmit the beacon signals. That is, unlike the conventional technique, all of the radio terminals need not regularly transmit the electric (field) intensity measurement signals to another radio terminals. This makes it possible to prevent a situation in which the number of times the signals are transmitted and received between the radio terminals increases and hence electric power consumption in the radio terminals increases. As a result, it becomes possible to prevent a situation in which a traffic increases and a reliability of the system degrades.

Therefore, the radio terminal according to the tenth aspect of the present invention can newly participate in the radio communication system with a simple configuration without a locational constraint, while ensuring a high reliability of the radio communication system.

According to an eleventh aspect of the present invention, there is provided a radio terminal which is incorporated in a radio communication system including: a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal; wherein in the radio terminal which is incorporated in the radio communication system, a beacon signal is regularly transmitted from the radio terminal which is an upper device to the radio terminal which is a lower device; and wherein the radio terminal which is the lower device further includes: a reception level determiner unit for determining whether or not a reception level B is equal to or lower than a value derived by subtracting a specified level C from a reception level A; and a new connection target deciding unit for newly deciding as a connection target the radio terminal which is the upper device, when the reception level determiner unit determines that the reception level B is equal to or lower than the value derived by subtracting the specified level C from the reception level A, the reception level A being a reception level of the beacon signal received from the radio terminal which is the upper device decided as the connection target by the radio terminal which is the lower device, when the radio terminal which is the lower device newly participates in the radio communication system, the reception level B being a reception level of the beacon signal regularly received from the radio terminal which is the upper device, and the specified level C being a value set in a range within which a decrease in the reception level from the reception level A is allowed.

In accordance with this configuration, the reception level determiner unit included in the radio terminal enables for example, the radio terminal which is the lower device to determine whether or not the reception level of the beacon signal regularly received from the radio terminal which is the upper device is lowered due to a change in electric waves surrounding this radio terminal. Especially, the reception level determiner unit is able to determine whether or not the lowered reception level is equal to or lower than the value derived by subtracting the specified level C from the reception level A. This makes it possible to determine whether or not the reception level of the beacon signal regularly received from the radio terminal which is the upper device is lowered from the value of the reception level A significantly beyond an allowable range.

In addition, the new connection target deciding unit included in the radio terminal makes it possible to newly decide as the connection target the radio terminal which is the upper device, in the case where the reception level of the beacon signal regularly received is lowered from the value of the reception level A significantly beyond the allowable range.

Because of the above, in the radio terminal according to the eleventh aspect, it becomes possible to review the connection target only in the case where the reception level of the beacon signal regularly received does not satisfy a desired communication quality, without a need to frequently review the connection target depending on a fluctuation in the reception level of the beacon signal regularly received. Then, it becomes possible to newly decide the radio terminal which is the connection target and change a route up to the radio master terminal. Thus, unlike the conventional technique, all of the radio terminals need not regularly transmit the electric (field) intensity measurement signals to another radio terminals or receive the electric (field) intensity measurement signals transmitted from another radio terminals. That is, unlike the conventional technique, the number of times the signals are transmitted and received between the radio terminals to change the relay route does not increase, and therefore it becomes possible to avoid a problem that a traffic increases or a problem that electric power consumption increases.

According to a twelfth aspect of the present invention, there is provided a method of controlling a radio terminal which newly participates in a radio communication system including: a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal; wherein the radio master terminal and the radio relay terminal are configured to transmit beacon signals each containing radio relay terminal number information which is information indicating the number of another radio relay terminals via which communication with the radio master terminal is performed, the method comprising the steps of: measuring reception levels of the received beacon signals; obtaining the radio relay terminal number information from each of the beacon signals; and deciding as a connection target the radio terminal which is a transmission source of the beacon signal in which the measured reception level of the beacon signal is equal to or higher than a specified value, and the number of another radio relay terminals is smallest based on the obtained radio relay terminal number information.

According to a thirteenth aspect of the present invention, there is provided a method of controlling a radio terminal which is incorporated in a radio communication system and serves as a lower device, the radio communication system including: a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal; wherein in the radio terminal which is incorporated in the radio communication system, a beacon signal is regularly transmitted from the radio terminal which is an upper device to the radio terminal which is a lower device; the method comprising the steps of: determining whether or not a reception level B is equal to or lower than a value derived by subtracting a specified level C from a reception level A; and newly deciding as a connection target the radio terminal which is the upper device, when it is determined that the reception level B is equal to or lower than the value derived by subtracting the specified level C from the reception level A, the reception level A being a reception level of the beacon signal received from the radio terminal which is the upper device decided as the connection target by the radio terminal which is the lower device, when the radio terminal which is the lower device newly participates in the radio communication system, the reception level B being a reception level of the beacon signal regularly received from the radio terminal which is the upper device, and the specified level C being a value set in a range within which a decrease in the reception level from the reception level A is allowed.

It should be noted that the above stated radio terminal may be implemented by a computer. In this case, a control program of the radio terminal which causes the computer to operate as the above mentioned units to implement the radio terminal in the computer, and a computer-readable storage medium which contains the control program are within the scope of the present invention.

Hereinafter, preferred embodiments of the present invention will be described with reference to the drawings. Throughout the drawings, the same or corresponding components are designated by the same reference symbols and will not be described in repetition. The embodiments are in no way intended to limit the present invention.

### Embodiment 1

### Schematic Configuration of Radio Communication System

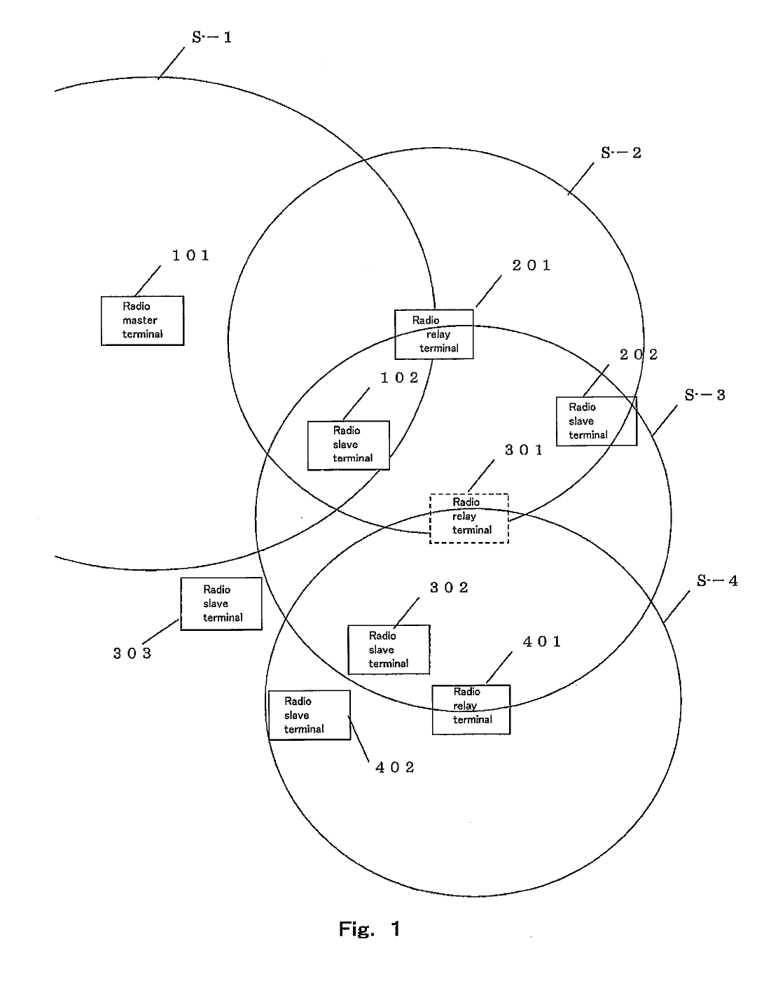

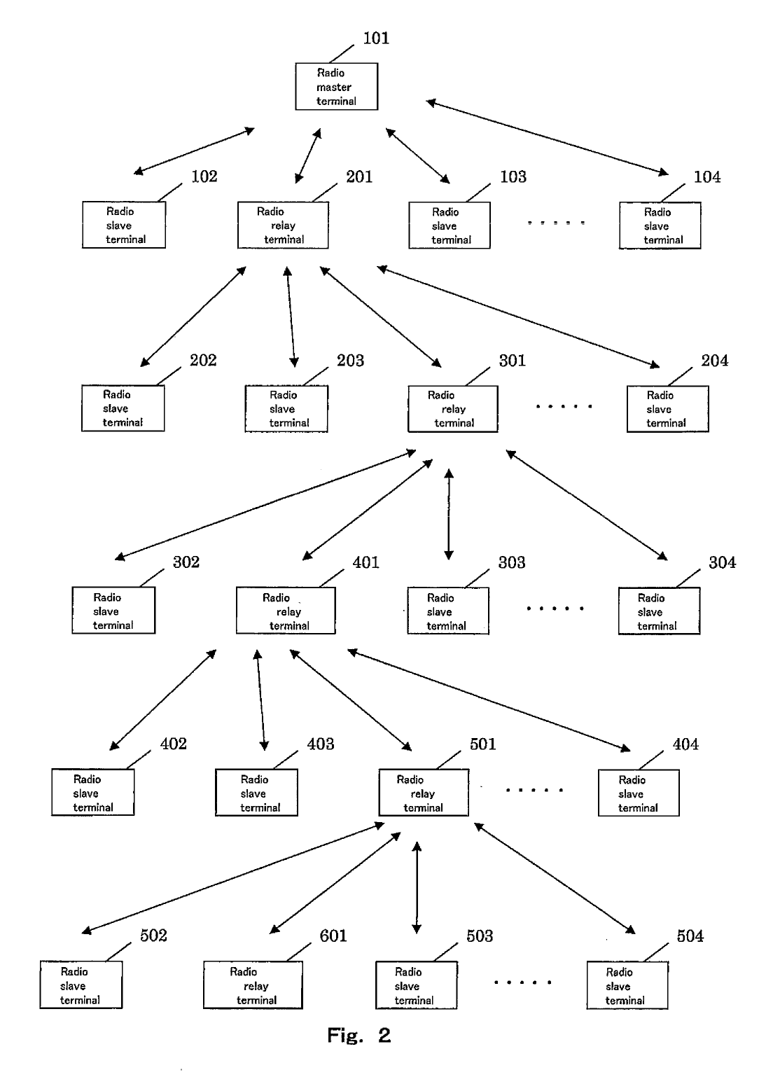

The configuration of the radio (wireless) communication system according to Embodiment 1 of the present invention will be described with reference to FIGS. 1 and 2.

FIG. 1 is view showing an exemplary communication area configuration in the radio communication system according to Embodiment 1 of the present invention. FIG. 2 is a view showing exemplary hierarchal (three) structures of the radio communication system according to Embodiment 1 of the present invention.

As shown in FIGS. 1 and 2, the radio communication system according to Embodiment 1 includes as radio terminals a radio master (access point) terminal 101, radio relay terminals 201, 301, 401, 501, 601, and radio slave terminals 102 to 104, 202 to 204, 302 to 304, 402 to 404, 502 to 504. For easier description, one radio master terminal, five radio relay terminals (radio relay terminals 201, 301, 401, 501, 601), and fifteen radio slave terminals (radio slave terminals 102 to 104, 202 to 204, 302 to 304, 402 to 404, 502 to 504) are shown in FIG. 2. However, the configuration of the radio communication system is not limited to this. The radio terminals which are more in number than those illustrated may be provided, or the radio terminals which are less in number than those illustrated may be provided. According to the purpose of construction of the radio communication system, the radio relay terminals and the radio slave terminals are suitably provided.

In a case where the radio master terminal 101, the radio relay terminals 201, 301, 401, 501, 601, and the radio slave terminals 102 to 104, 202 to 204, 302 to 304, 402 to 404, 502 to 504 need not be especially distinguished from each other, they will be simply referred to as radio terminals.

The radio master terminal 101, and the radio relay terminals 201, 301, 401, 501 are radio terminals which transmit beacon signals. The radio relay terminals 201, 301, 401, 501 and the radio slave terminals 102 to 104, 202 to 204, 302 to 304, 402 to 404, 502 to 504 are radio terminals which receive the beacon signals. That is, it may be interpreted that the radio relay terminals 201, 301, 401, 501 are radio terminals which are capable of transmitting and receiving the beacon signals.

In the radio communication system, for example, as shown in FIG. 2, the radio slave terminals 102 to 104 are directly communicable with the radio master terminal 101. More specifically, the radio master terminal 101 is able to transmit the beacon signal to each of the radio slave terminals 102 to 104 and the radio relay terminal 201, and to perform data communication with the radio slave terminals 102 to 104 and the radio relay terminal 201 via radio waves. Therefore, in FIG. 2, these radio terminals are connected to each other by bidirectional arrows. The radio master terminal 101, the radio slave terminals 102 to 104 and the radio relay terminal 201 constitute a first hierarchical (tree) network in the radio communication system. The radio master terminal 101 is an “upper device” from the perspective of the radio slave terminals 102 to 104 and the radio relay terminal 201. Conversely, the radio slave terminals 102 to 104 and the radio relay terminal 201 are “lower devices” from the perspective of the radio master terminal 101.

The radio slave terminals 202 to 204 establish communication with the radio master terminal 101 via the radio relay terminal 201. More specifically, the radio relay terminal 201 is able to transmit the beacon signal to the radio slave terminals 202 to 204 and the radio slave terminal 301 and to perform data communication with the radio slave terminals 202 to 204 and the radio relay terminal 301. For this reason, the radio relay terminal 201 is a “lower device” from the perspective of the radio master terminal 101, but is an “upper device” from the perspective of the radio slave terminals 202 to 204 and the radio relay terminal 301. The radio relay terminal 201, the radio slave terminals 202 to 204 and the radio relay terminal 301 constitute a second hierarchical network in the radio communication system.

The radio slave terminals 302 to 304 establish communication with the radio master terminal 101 via the radio relay terminals 301, 201. More specifically, the radio relay terminal 301 is able to transmit the beacon signal to the radio slave terminals 302 to 304 and the radio relay terminal 401 and to perform data communication with the radio slave terminals 302 to 304 and the radio relay terminal 401. For this reason, the radio relay terminal 301 is a “lower device” from the perspective of the radio relay terminal 201 but is an “upper device” from the perspective of the radio slave terminals 302 to 304 and the radio relay terminal 401. The radio relay terminal 301, the radio slave terminals 302 to 304 and the radio relay terminal 401 constitute a third hierarchical network in the radio communication system.

The radio slave terminals 402 to 404 perform communication with the radio master terminal 101 via the radio relay terminals 401, 301, 201. The radio slave terminals 502 to 504 perform communication with the radio master terminal 101 via the radio relay terminals 501, 401, 301, 201. That is, the radio relay terminal 401 is able to transmit the beacon signal to the radio slave terminals 402 to 404 and the radio relay terminal 501 and to perform data communication with these radio terminals (radio slave terminals 402 to 404, radio relay terminal 501). The radio relay terminal 401, the radio slave terminals 402 to 404, and the radio relay terminal 501 constitute a fourth hierarchical network in the radio communication system. The radio relay terminal 501 is able to transmit the beacon signal to the radio slave terminals 502 to 504 and the radio relay terminal 601 and to perform data communication with these radio terminals (radio slave terminals 502 to 504, radio relay terminal 601). The radio relay terminal 501, the radio slave terminals 502 to 504 and the radio relay terminal 601 constitute a fourth hierarchical network in the radio communication system.

As described above, the radio communication system is able to constitute multiple hierarchical networks using the radio terminals as the upper devices and the radio terminals as the lower devices. A case where connection with the radio master terminal is established via one radio relay terminal will be referred to as “one relay stage”, while a case where connection with the radio master terminal is established via n radio relay terminals will be referred to as “the number of relay stages n” (relay stage number n).

Next, with reference to FIG. 1, the communication area of the radio communication system according to Embodiment 1 will be described with reference to FIG. 1. Area S-1 is an area in which communication with the radio master terminal 101 with a specified communication quality is enabled. In other words, the area S-1 is a range in which the reception level of electric wave (radio wave) (electric wave carrying beacon signal) from the radio master terminal 101, i.e., electric (field) intensity level is equal to or higher than a first specified value. The first specified value may be decided in view of a noise level which might disturb a signal for transmitting information under a general environment, including, for example, a thermal noise level, etc. In Embodiment 1, the first specified value is set to, for example, −100 dBm.

Area S-2, area S-3, and area S-4 are areas in which communication with the radio relay terminals 201, 301, 401 with a specified communication quality is enabled. In other words, the area S-2, the area S-3, and the area S-4 are ranges in which the reception level of the electric wave from the radio relay terminals is equal to or higher than a second specified value. The second specified value may be equal to the first specified value or may be set to a value, for example, −90 dBm, which is higher than the first specified value (−100 dBm). The second specified value may be preferably set to a value having a margin as compared to the first specified value, considering, for example, motions of persons, presence or absence of obstacles such as walls, under an environment in which the radio communication system is actually installed. This is because as the relay stage number n increases, a communication quality in the whole system will get worse and become inferior to the desired communication quality, even if a communication quality in one communication area is equal to or higher than a desired communication quality. In view of this, it is desired that the communication quality of the communication area which can be covered by the radio relay terminals be set higher than that of the communication area which can be covered by the radio master terminal 101.

Alternatively, depending on the relay stage number in the radio communication system, plural thresholds may be set as the second specified value. As described above, the communication area which can be covered by the radio master terminal 101 is defined as the range in which the reception level of electric wave transmitted from the radio master terminal 101 is equal to or higher than the first specified value. Alternatively, the communication area which can be covered by the radio master terminal 101 and the radio relay terminal 201 . . . corresponding to a relay stage number which is less than a relay stage number m may be defined as the above range in which the reception level is equal to or higher than the first specified value.

As shown in FIG. 1, for example, the radio slave terminal 102 lies in three areas which are the communication area S-1 of the radio master terminal 101, the communication area S-2 of the radio relay terminal 201, and the communication area S-3 of the radio relay terminal 301. That is, the radio slave terminal 102 is in a state in which it is able to receive the electric wave transmitted from the radio master terminal 101 with a reception level which is equal to or higher than the first specified value. Also, the radio slave terminal 102 is in a state in which it is able to receive the electric wave transmitted from the radio relay terminal 201 and the radio relay terminal 301 with a reception level which is equal to or higher than the second specified value. The radio slave terminal 102 is physically closest to the radio relay terminal 201, and receives the electric wave transmitted from the radio relay terminal 201 with a highest reception level.

In the above described situation, in Embodiment 1, from among connection target candidates, the connection target selected by the radio slave terminal 102 is not the radio relay terminal 201 closest in distance to itself, but a radio terminal in which the relay stage number is smallest, i.e., the radio master terminal 101 in the example of FIG. 1.

If plural connection target candidates (radio master terminal 101, radio relay terminals 201, 301) exist, the radio slave terminal 102 determines the magnitude of the relay stage number, based on the relay stage number information (radio relay terminal number information) as will be described later, which information is received in the radio slave terminal 102 in a state in which the information is superposed on the beacon signals, from the respective radio terminals, and selects as the connection target the radio terminal in which the relay stage number is smallest.

Since the relay stage number information is thus superposed on the beacon signal, the radio slave terminal 102 can know the relay stage number of the radio relay terminal which transmits the beacon signal, by receiving the beacon signal. Therefore, when the radio slave terminal 102 receives the plural beacon signals when it newly participates in the radio communication system, it determines whether or not the reception level of each of the received beacon signals is equal to or higher than the first specified value or the second specified value. Furthermore, the radio slave terminal 102 selects the radio terminal which should be a connection target, based on the relay stage number information superposed on the received beacon signals.

Likewise, the radio slave terminal 202, 302 belongs to a plurality of communication areas of the radio relay terminals. The radio slave terminal 202, 302 selects as the connection target the radio relay terminal in which the relay stage number is smallest. As a result, the radio slave terminal 202 selects the radio relay terminal 201 as the connection target, while the radio slave terminal 302 selects the radio relay terminal 301 as the connection target. That is, when this is expressed using the tree structure of FIG. 2, the radio slave terminal 202 is subordinated to the radio relay terminal 201, and the radio slave terminal 302 is subordinated to the radio relay terminal 301.

In a case where a radio terminal, like the radio slave terminal 402, belongs to only the communication area of one radio relay terminal (radio relay terminal 401), it selects the radio relay terminal 401 as the connection target. That is, the radio slave terminal 402 is subordinated to the radio relay terminal 401.

In a case where a radio terminal, like the radio slave terminal 303, does not belong to any one of the communication areas of the radio master terminal 101 and the radio relay terminals 201, 301, 401, the radio slave terminal 303 selects as the connection target the radio master terminal 101, or the radio relay terminal 201, 301, 401 with which communication with a highest reception level is enabled. For example, in a case where the reception level of the electric wave received from the radio relay terminal 301 is highest, the radio slave terminal 303 selects as the connection target, the radio relay terminal 301 and is subordinated to the radio relay terminal 301.

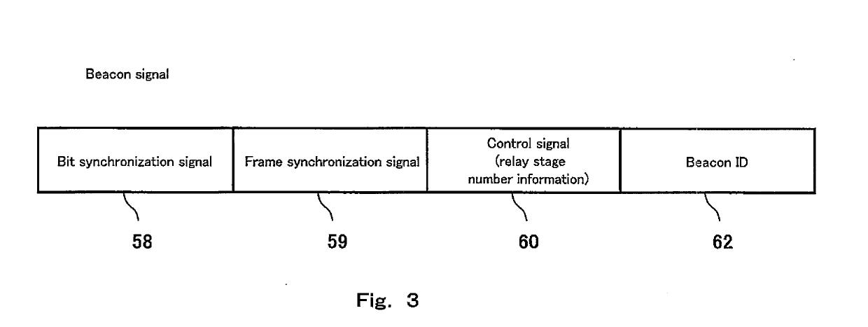

Now, the beacon signal transmitted between the radio terminals will be described in detail in detail. The beacon signal has a signal format of a frame configuration of FIG. 3. FIG. 3 is a view showing an exemplary frame configuration of the beacon signal transmitted between radio terminals in the radio communication system according to Embodiment 1 of the present invention.

Specifically, the frame configuration of the beacon signal is composed of a bit synchronization signal 58, a frame synchronization signal 59, a control signal 60, and a beacon ID 62. The beacon signal has a frame length of T6.

The bit synchronization signal 58 is a signal for deciding a sampling position of bit. The frame synchronization signal 59 is a signal for detecting a head of data contained in the beacon signal. The control signal 60 is a signal containing several kinds of control information, which are relay stage number information, information relating to the beacon ID, etc. The beacon ID is an identifier used to identify the radio terminal (radio master terminal 101 or radio relay terminal 201, 301, 401, 501) which transmits the beacon signal. Receiving the beacon signal, the radio terminal analyzes the beacon ID to identify the radio terminal which is a transmission source of the beacon signal.

### [Configuration of Radio Terminal]

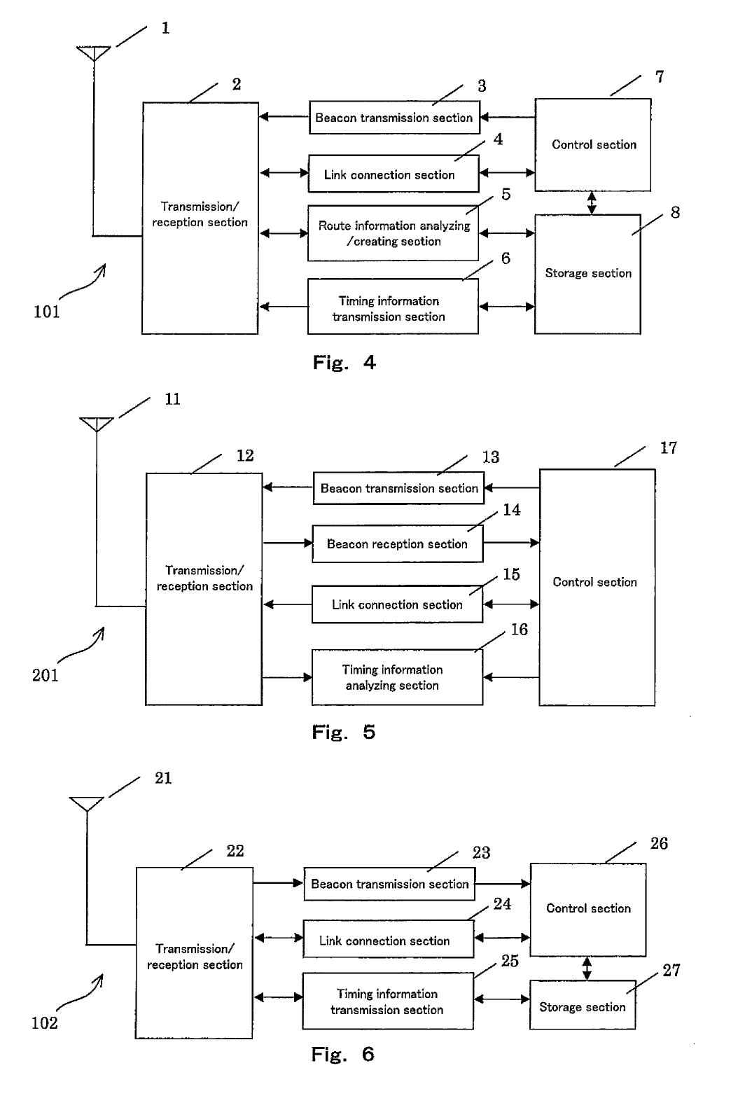

The configuration of each of the radio terminals which are included in the radio communication system as described above will be described with reference to FIGS. 4 to 6. FIG. 4 is a block diagram showing an exemplary configuration of major components of the radio terminal serving as the radio master terminal according to Embodiment 1 of the present invention. FIG. 5 is a block diagram showing an exemplary configuration of major components of the radio terminal serving as the radio relay terminal according to Embodiment 1 of the present invention. FIG. 6 is a block diagram showing an exemplary configuration of major components of the radio terminal serving as the radio slave terminal according to Embodiment 1 of the present invention.

Initially, with reference to FIG. 4, the configuration of the radio master terminal 101 according to Embodiment 1 will be described. The radio master terminal 101 includes an antenna 1, a transmission/reception section 2, a control section 7, a storage section 8, a beacon transmission section 3, a link connection section 4, a route information analyzing/creating section 5 and a timing information transmission section 6.

The antenna 1 is not particularly limited so long as it is capable of transmitting/receiving an electric wave in a predetermined band. As the antenna 1, a known antenna capable of transmitting/receiving an electric wave in a band defined according to public standard may be used.

The transmission/reception section 2 is configured as a radio transmission/reception circuit which modulates data into a radio signal in a specified band or demodulates the radio signal in the specified band into the data, when the electric wave is transmitted and received via the antenna 1. A specific configuration of the transmission/reception section 2 is not particularly limited, and a radio frequency circuit (RF circuit) known in the field of a radio communication network is used.

The control section 7 is constituted by, for example, a CPU, and performs control processes relating to the operation of the radio master terminal 101 (radio terminal), in particular, radio communication operation of the radio master terminal 101. The control processes relating to the radio communication operation include providing control commands to the sections such as the beacon transmission section 3, the link connection section 4, the route information analyzing/creating section 5, and the timing information transmission section 6.

The storage section 8 is a storage medium which is readable and writable, and may be configured as an internal memory of the CPU, an independent memory, etc. The storage section 8 contains a route information table and the associated information relating to the route information table. The route information table contains information of device IDs of devices so that links among all of the radio terminals in the radio communication system are seen. To see links from the radio master terminal 101 up to the radio terminals subordinated to the radio master terminal 101, the route information table contains device IDs of devices via which a target radio terminal is reached. For example, regarding the radio slave terminal 302 linked to the radio master terminal 101 via the radio relay terminal 201 and the radio relay terminal 301, the route information table contains the table so that links (subordination) among the device ID of the radio relay terminal 201, the device ID of the radio relay terminal 301, and the device ID of the radio slave terminal 302 are seen.

The beacon transmission section 3 transmits the beacon signal to another radio terminals (radio relay terminal 201, radio slave terminals 102 to 104 as will be described later) in response to the control command from the control section 7.

The link connection section 4 transmits a link connection signal 50 to another radio terminal and performs a connection operation of radio link (link connection operation) in response to the control command from the control section 7. The link connection signal 50 will be described in detail later.

The route information analyzing/creating section 5 analyzes and creates route information 87 including information (radio relay terminal information 90) relating to the radio relay terminal 201 for which a relay request was made, in response to the control command from the control section 7.

The timing information transmission section 6 creates and transmits information (intermittent reception timing information) used to identify an intermittent reception timing in the radio slave terminal which is a lower device such as the radio slave terminal 102, for the radio master terminal 101, in response to the control command from the control section 7.

The intermittent reception timing information is expressed as slot position information 91 as will be described later. The route information 87 contains the slot position information 91 in addition to the radio relay terminal information 90. The radio relay terminal information 90 and the slot position information 91 will be described in detail later.

Specific configurations of the beacon transmission section 3, the link connection section 4, the route information analyzing/creating section 5, and the timing information transmission section 6 are not particularly limited. The beacon transmission section 3, the link connection section 4, the route information analyzing/creating section 5, and the timing information transmission section 6 may be each configured as a known logic circuit or the like including a switching element, a subtractor, a comparator, etc., or may be implemented by, for example, the operation of the CPU as the control section 7 in which the program is read from the storage section 14 or the memory (not shown) and executed.

The configuration of the radio relay terminal will be described with reference to FIG. 5. For easier understanding, in the present embodiment, the radio relay terminal 201 will be described as a representative radio relay terminal, among the plurality of radio relay terminals. The radio relay terminal 201 includes an antenna 11, a transmission/reception section 12, a beacon transmission section 13, a beacon reception section 14, a link connection section 15, a timing information analyzing section 16 and a control section 17.

Specific configurations of the antenna 11, the transmission/reception section 12, the control section 17, the beacon transmission section 13, and the link connection section 15 in the radio relay terminal 201 are the same as the antenna 1, the transmission/reception section 2, the control section 7, the beacon transmission section 3, and the link connection section 4 in the radio master terminal 101, and will not be described in repetition. However, the link connection section 15 is different from the link connection section 4 in that when the radio relay terminal 201 receives the link connection signal 50 transmitted from the radio master terminal 101, the link connection section 15 performs a link connection operation.

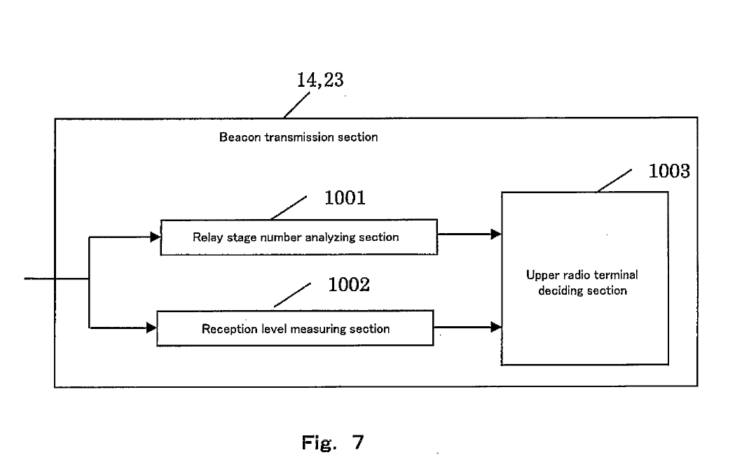

The beacon reception section 14 decides a radio terminal which is a connection target for the radio relay terminal 201 based on the beacon signal transmitted from an upper device for the radio relay terminal 201, for example, the radio master terminal 101. More specifically, as shown in FIG. 7, the beacon reception section 14 includes a relay stage number analyzing section (information obtaining unit) 1001, a reception level measuring section (measuring unit) 1002, and an upper radio terminal deciding section (deciding unit) 1003. FIG. 7 is a block diagram showing an exemplary configuration of the beacon reception section 14 of the radio terminal according to Embodiment 1 of the present invention. The relay stage number analyzing section 1001, the reception level measuring section 1002, and the upper radio terminal deciding section 1003 are part of functions implemented by the beacon reception section 14. These members decide the radio terminal which is the connection target.

The relay stage number analyzing section 1001 analyzes the received beacon signal to know the relay stage number. Specifically, the relay stage number analyzing section 1001 analyzes the beacon signal to know the relay stage number in a case where the radio relay terminal 201 performs communication with the radio master terminal 101 via the radio terminal which is a transmission source of this beacon signal.

The reception level measuring section 1002 measures the reception level of the received beacon signal.

The upper radio terminal deciding section 1003 decides a radio terminal which is a connection target for the radio relay terminal 201, based on a result of the analysis performed by the relay stage number analyzing section 1001 and a result of the reception level measured by the reception level measuring section 1002, and performs notification of a result to the control section 7.

When a power supply of the radio relay terminal 201 is ON, and the radio relay terminal 201 newly participates in the radio communication system, the beacon reception section 14 receives the beacon signals for a specified period. The relay stage number analyzing section 1001 finds the relay stage number in a case where connection is made via which the radio terminal which transmitted the beacon signal, based on the relay stage number information contained in the beacon signal, for all of the beacon signals received for the specified period. The reception level measuring section 1002 measures reception levels of all of the received beacon signals. Then, the upper radio terminal deciding section 1003 decides a radio terminal which is a connection target, based on a result of the analysis performed by the relay stage number analyzing section 1001 and a result of the reception level measured by the reception level measuring section 1002, and performs notification of a result to the control section 17.

The timing information analyzing section 16 analyzes and creates the route information 87 including the slot position information, in response to the control command from the control section 17.

The beacon reception section 14 and the timing information analyzing section 16 may be configured as logic circuits, etc., or may be implemented by the operation of the control section 17 in which the program is read from the memory (not shown) and executed.

Next, the configuration of the radio slave terminal will be described with reference to FIG. 6. For easier understanding, in the present embodiment, the radio slave terminal 102 will be described as a representative radio slave terminal, among the plurality of radio slave terminals. The radio slave terminal 102 includes an antenna 21, a transmission/reception section 22, a control section 26, a storage section 27, a beacon reception section 23, a link connection section 24, and a timing information transmission section 25. The specific configurations of the antenna 21, the transmission/reception section 22, the control section 26, the storage section 27, the link connection section 24 and the timing information transmission section 25 are the same as the antenna 1, the transmission/reception section 2, the control section 7, the storage section 8, the link connection section 4 and the timing information transmission section 6 of the radio master terminal 101, and will not be described in repetition. The configuration of the beacon reception section 23 is the same as that of the beacon reception section 14 of the radio relay terminal 201 and will not be described in repetition.

Each of the radio terminals shown in FIGS. 4 to 6 is configured to perform communication in such a way that a time axis is divided into plural slots as will be described later. In a slot (beacon transmission slot 31) prepared for transmission of the beacon, the beacon transmission section 3 or the beacon transmission section 13 transmits the beacon. In a slot (beacon reception slot 34) prepared for reception of the beacon, the beacon reception section 14 or the beacon reception section 23 receives the beacon. Moreover, in a slot for link connection (link connection slot 32, 35), the link connection section 4, the link connection section 15 or the link connection section 24 performs a link connection operation.

### (Connection Target Deciding Process)

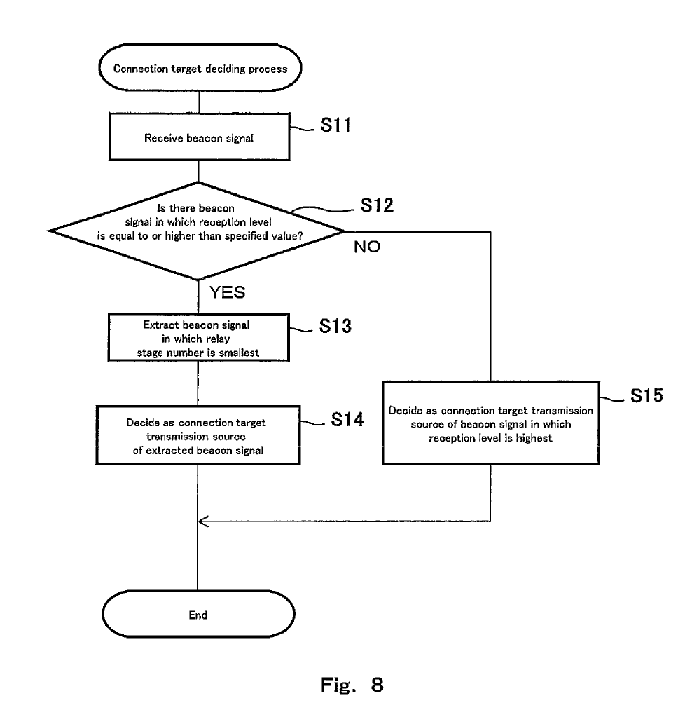

Next, the connection target deciding process performed by the radio relay terminal or the radio slave terminal configured as described above will be described with reference to FIG. 8. FIG. 8 is a flowchart showing an exemplary connection target deciding process performed by the radio relay terminal and the radio slave terminal according to Embodiment 1 of the present invention.

In Embodiment 1, in a case where the radio terminal (radio relay terminal or the radio slave terminal) is newly placed in the radio communication system, the newly placed radio terminal is configured to decide another radio terminal which is a connection target for itself.

Specifically, the radio terminal decides another radio terminal which is the connection target as described below. For easier understanding, hereinafter, it is supposed that the radio slave terminal 302 is newly placed in the radio communication system of FIG. 1.

Initially, in the radio slave terminal 302, the beacon reception section 23 receives a beacon signal transmitted from an upper device for itself (step S11). Receiving the beacon signal, the reception level measuring section 1002 of the beacon reception section 23 determines whether or not there is a beacon signal in which a reception level is equal to or higher than a specified value, among the received beacon signals (step S12). In the radio slave terminal 302 of Embodiment 1, the reception level measuring section 1002 determines whether or not there is a beacon signal in which the reception level is equal to or higher than the above stated second specified value, among the received beacon signals.

If the reception level measuring section 1002 determines that there are beacon signals in which reception levels are equal to or higher than the specified value, the beacon reception section 23 extracts the beacon signal in which the relay stage number is smallest, from the beacon signals in which the reception levels are equal to or higher than the specified value (step S13). As described previously, the relay stage number information is superposed on each beacon signal. Therefore, the relay stage number analyzing section 1001 checks the relay stage number information for each of the beacon signals in which the reception levels are equal to or higher than the specified value and extracts the beacon signal in which relay stage number is smallest. Then, the upper radio terminal deciding section 1003 decides as the connection target, a radio terminal which is a transmission source of the beacon which is extracted by the relay stage number analyzing section 1001 (step S14).

In Embodiment 1, the beacon signals determined as having the reception levels which are equal to or higher than the specified value, by the reception level measuring section 1002 of the radio slave terminal 302, are the beacon signal transmitted from the radio relay terminal 301 and the beacon signal transmitted from the radio relay terminal 401. Of these two beacon signals, the beacon signal determined as being smallest in relay stage number by the relay stage number analyzing section 1001 is the beacon signal transmitted from the radio relay terminal 301.

Therefore, the upper radio terminal deciding section 1003 decides as the connection target, the radio relay terminal 301 which is a transmission source of the beacon signal extracted by the relay stage number analyzing section 1001.

If NO in step S12, i.e., the reception level measuring section 1002 determines that there exists no beacon signal in which the reception level is equal to or higher than the specified value, the upper radio terminal deciding section 1003 decides as the connection target, a transmission source of the beacon signal in which the reception level is highest, among the received beacon signals (step S15).

In the above described manner, the radio terminal newly placed in the radio communication system is able to decide the connection target for itself, and hence the upper device to which this radio terminal newly placed is subordinated.

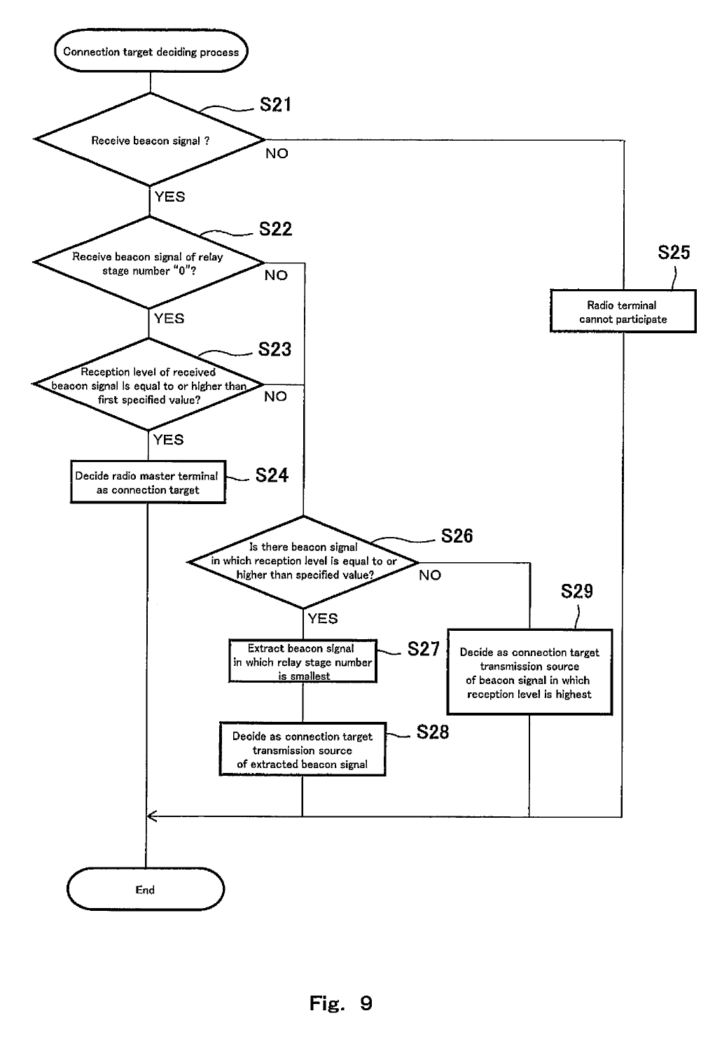

In Embodiment 1, in a case where the transmission source of the beacon signal received by the radio terminal is the radio master terminal 101, the reception level measuring section 1002 determines whether or not the reception level of that beacon signal is equal to or higher than the first specified value. On the other hand, in a case where the transmission source of the beacon signal received by the radio terminal is a radio relay terminal lower than the radio master terminal 101, the reception level measuring section 1002 determines whether or not the reception level of that beacon signal is equal to or higher than the second specified value. Thus, in the configuration for changing the threshold used to determine the reception level of the beacon signal depending on whether the transmission source of the beacon signal is the radio master terminal or the radio relay terminal, it is determined in advance whether the connection target will be the radio master terminal or the radio terminal (radio relay terminal) other than the radio master terminal, and then the above mentioned connection target deciding process may be executed, as shown in FIG. 9 below. FIG. 9 is a flowchart showing an exemplary connection target deciding process performed by the radio relay terminal and the radio slave terminal according to Embodiment 1 of the present invention.

More specifically, in the radio slave terminal 302, after it is newly placed in the radio communication system, the beacon reception section 23 determines whether or not there is a beacon signal which can be received within the specified period (step S21). If the beacon reception section 23 cannot receive any beacon signal (“NO” in step S21), it determines that the radio slave terminal 302 cannot participate in the radio communication system (step S25).

On the other hand, if “YES” in step S21, the relay stage number analyzing section 1001 checks whether or not there is a beacon signal in which the relay stage number is “0”, from among the received beacon signals (step S22). If the relay stage number analyzing section 1001 determines that there is a beacon signal in which the relay stage number is “0” (“YES” in step S22), the reception level measuring section 1002 determines whether or not the reception level of this beacon signal is equal to or higher than the first specified value (step S23). If the reception level measuring section 1002 determines that the reception level of this beacon signal is equal to or higher than the first specified value (“YES” in step S23), the upper radio terminal deciding section 1003 decides the radio master terminal 101 as the connection target (step S24).

On the other hand, if “NO” in step S22, i.e., if the relay stage number analyzing section 1001 determines that the beacon signal in which the relay stage number is “0” does not exist, among the received beacon signals, the reception level measuring section 1002 determines whether or not there is a beacon signal in which the reception level of this beacon signal is equal to or higher than the second specified value, among the received beacon signals (step S26). If “NO” in step S23, i.e., if the reception level measuring section 1002 determines that the reception level of this beacon signal in which the relay stage number is “0” is not equal to or higher than the first specified value, the process also moves to step S26.

If the reception level measuring section 1002 determines that there is a beacon signal in which the reception level is equal to or higher than the second specified value (“YES” in step S26), the process moves to step S27. On the other hand, if the reception level measuring section 1002 determines that a beacon signal in which the reception level is equal to or higher than the second specified value does not exist (“NO” in step S26), the process moves to step S29. Step S27 to step S29 which will occur thereafter are the same as step S13 to step S15 of FIG. 8 and will not be described in repetition.

### [Operation of Radio Terminals in Radio Communication System]

Next, an outline of operations of the respective radio terminals in the overall radio communication system will be described in detail with reference to FIG. 2 again. It is assumed that the radio master terminal 101 can be directly connected to the radio slave terminals 102 to 104, but cannot be directly connected to the radio slave terminals 202 to 204, 302 to 304, 402 to 404, and 502 to 504 and cannot establish communication with them, due to bad electric wave conditions. Because of this, the radio master terminal 101 is adapted to be connected to the radio slave terminals 202 to 204, 302 to 304, 402 to 404, and 502 to 504, via the radio relay terminals 201, 301, 401, 501, etc.

The radio master terminal 101 which is the upper device regularly transmits the beacon signal (including signal for clock synchronization). The radio slave terminals 102 to 104, and the radio relay terminal 201, which are lower devices for the radio master terminal 101 and directly connected to the radio master terminal 101, regularly capture this beacon signal, and synchronize their clocks with the clock of the radio master terminal 101.

The radio relay terminal 201 serves as the upper device for the radio slave terminals 202 to 204 and the radio relay terminal 301, and regularly transmits the beacon signal to the radio slave terminals 202 to 204 and the radio relay terminal 301. The radio slave terminals 202 to 204 and the radio relay terminal 301 which are lower devices for the radio relay terminal 201 and are directly connected to the radio relay terminal 201 regularly capture this beacon signal, and synchronize their clocks with the clock of the radio relay terminal 201. Likewise, the radio relay terminal 301 serves as the upper device for the radio slave terminals 302 to 304, and the radio relay terminal 401, the radio relay terminal 401 serves as the upper device for the radio slave terminals 402 to 404, and the radio relay terminal 501, and the radio relay terminal 501 serves as the upper device for the radio slave terminals 502 to 504. The radio terminals which serve as the lower devices for the radio relay terminals 301, 401, 501 regularly capture the beacon signals regularly transmitted from their upper devices and synchronize their clocks with clocks of the upper devices.

### [Slot Configuration and Slot Positional Relationship of Radio Terminals]

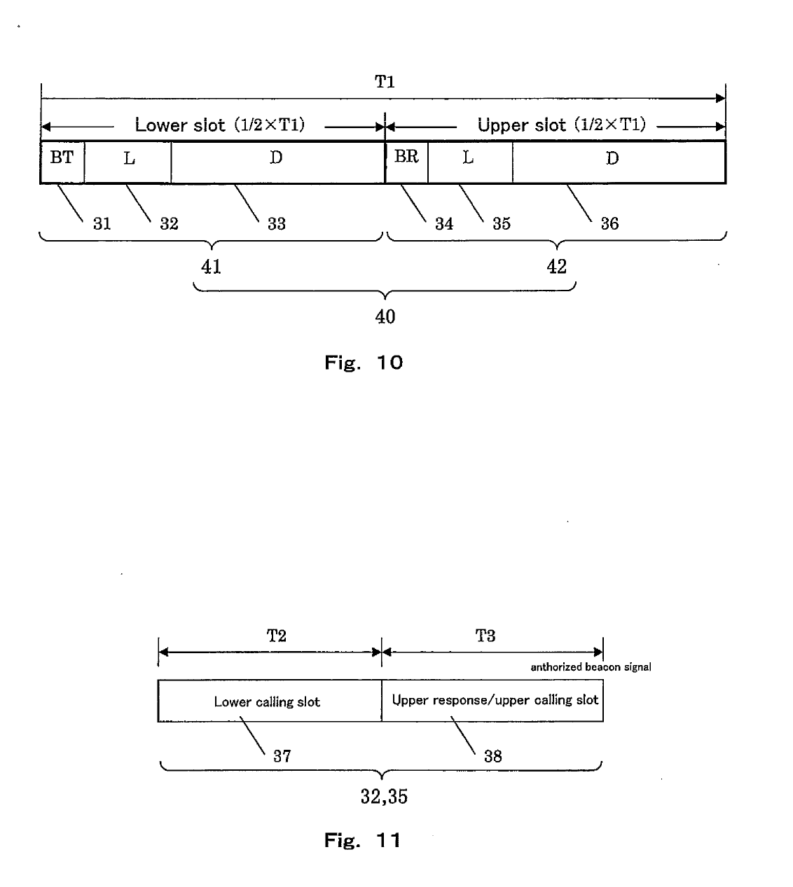

Now, a description will be specifically given of a method in which the radio slave terminal decides the radio relay terminal or the radio master terminal as the connection target and is subordinated as the lower device to the radio relay terminal or the radio master terminal. Prior to describing the method in which the radio slave terminal is subordinated as the lower device to another radio terminal, the slot configuration managed by each radio terminal will be described with reference to FIGS. 10 and 11. FIG. 10 is a view showing an exemplary slot configuration managed by the radio terminal according to Embodiment 1 of the present invention. FIG. 11 is a view showing an exemplary link connection slot 32, 35 included in a slot (base slot 40) of FIG. 10.

In the radio communication system of the present embodiment, data communication is performed by a time-division multiplexing method between the radio terminal as “upper device” and the radio terminal as “lower device”. Therefore, one cycle of radio communication is divided into a plurality of time slots (base slots 40), and specified communication data (radio signal) is allocated to each of the time slots (base slots 40) and communicated.

### (Basic Configuration of Time Slots)

In the time-division multiplexing method, radio communication is partitioned for each preset predetermined time and this predetermined time (1 cycle) is divided into a plurality of time slots. As shown in FIG. 10, a length (slot length) of a base time slot (base slot 40) is set to T1 seconds (e.g., T1=2 seconds). In communication, the base slot 40 is repeated on a time axis of one cycle. In Embodiment 1, one cycle is composed of 256 base slots 40 which are repeated in every cycle.

The base slot 40 is composed of two time slots which are a lower slot 41 and an upper slot 42. A slot length of the lower slot 41 and a slot length of the upper slot 42 are each set to a half (½×T1) of the slot length T1 of the base slot 40. The lower slot 41 is a time slot used to communicate with the lower device, while the upper slot 42 is a time slot used to communicate with the upper device.

The lower slot 41 is divided into three time slots which are a beacon transmission slot 31 (BT in FIG. 10), a link connection slot 32 (L in FIG. 10), and a data communication slot 33 (D in FIG. 10). Likewise, the upper slot 42 is divided into three time slots which are a beacon reception slot 34 (BR in FIG. 10), a link connection slot 35 (L in FIG. 10), and a data communication slot 36 (D in FIG. 10).

When the radio terminal acts as the upper device, the beacon transmission section 3, 13 (see FIG. 4, 5) regularly transmits the beacon signal to the lower device in the beacon transmission slot 31. The beacon signal may be transmitted without fail in the beacon transmission slot 31, or once in every plural beacon transmission slots 31. For example, in the case where the beacon transmission section 3, 13 is adapted to transmit the beacon signal once in every two beacon transmission slots 31 (transmit the beacon signal once in every two slots), a transmission interval of the beacon signal is 4 seconds when T1=2 seconds.

When the radio terminal acts as the lower device, the beacon reception section 14, 23 (see FIG. 5, 6) regularly receives the beacon signal from the upper device in the beacon reception slot 34. A reception interval of the beacon signal can be set to an integral multiple of the transmission interval of the beacon signal. For example, when the transmission interval is set to 2 seconds and the reception interval is set to a time interval which is 256 times as long as the transmission interval, the reception interval is 8 minutes 32 seconds.

Regardless of whether the radio terminal is the upper device or the lower device, the link connection section 4, 15, 24 (see FIGS. 4 to 6) performs the link connection operation in the link connection slot 32, 35. In the radio communication system of Embodiment 1, data communication between the radio terminals is enabled. The data communication takes place after the link connection operation. That is, the data communication (give and take of data) takes place in data communication slot 33, 36 following the link connection slot 32, 35.

As shown in FIG. 11, the link connection slot 32, 35 is composed of two time slots which are a lower calling slot 37 and an upper response/upper calling slot 38. The lower calling slot 37 is a time slot in which the lower device transmits the link connection signal 50 when the lower device wishes to perform link connection to the upper device. The upper response/upper calling slot 38 is a time slot in which the upper device sends a reply in response to the link connection signal 50 from the lower device, or the upper device transmits the link connection signal 50 when the upper device wishes to perform link connection to the lower device.

A slot length of the link connection slot 32, 35 is not particularly limited. In the example of FIG. 11, a slot length of the lower calling slot 37 is set to T2, while a slot length of the upper response/upper calling slot 38 is set to T3. Although the slot length T2 and the slot length T3 are depicted as substantially equal length (T2=T3) in FIG. 11, the present invention is not limited to this, but a suitable slot length may be set according to the transmission of the link connection signal 50 or a reply to the link connection signal 50.

### (Positional Relationship of Time Slots)

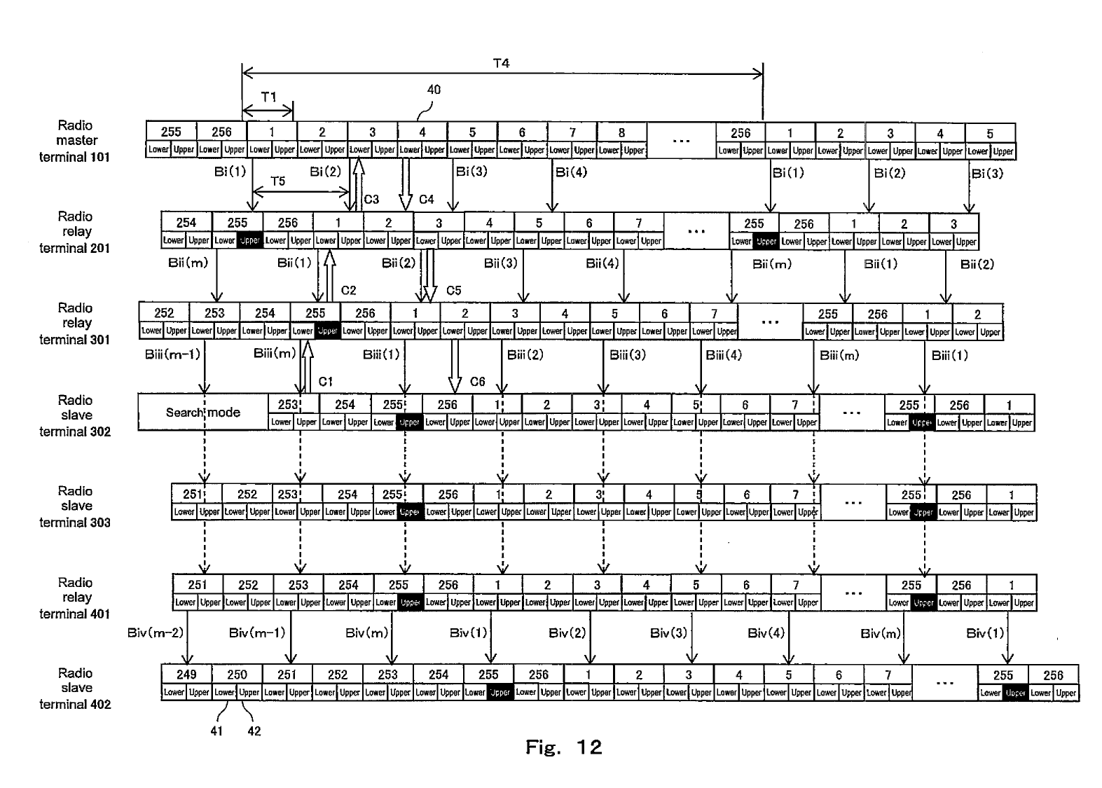

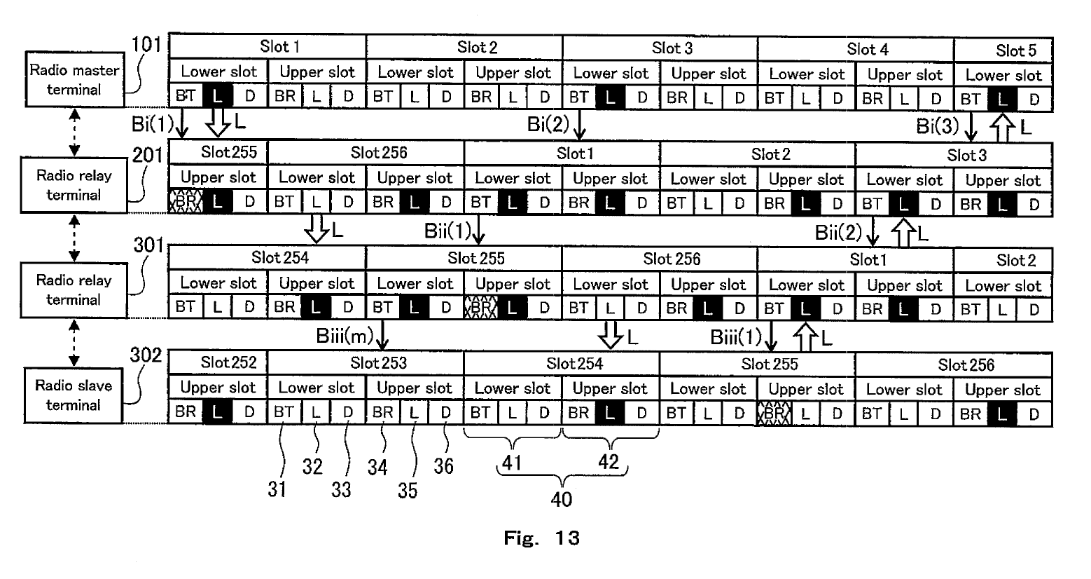

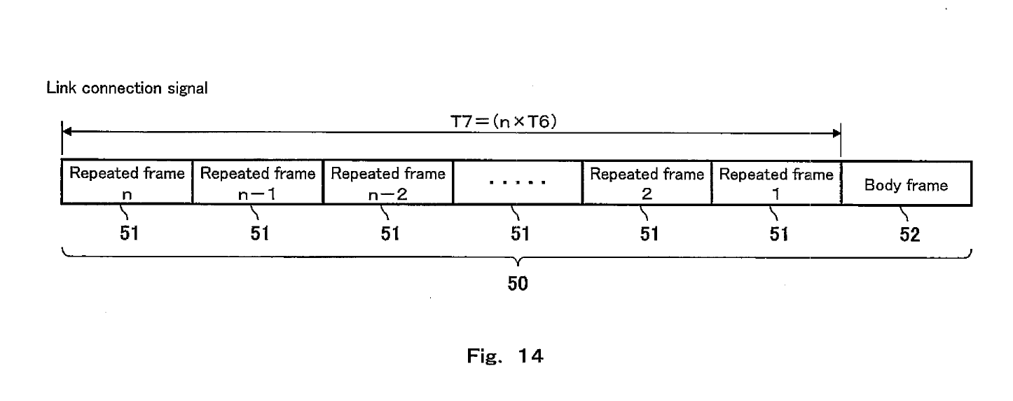

Next, the positional relationship of the time slots between the upper device and the lower device in the radio communication system of the present embodiment will be described specifically with reference to FIG. 12. FIG. 12 is a view showing an exemplary positional relationship between the time slots (base slots 40) of FIG. 10, which are managed in the radio terminals. FIG. 12 shows the positional relationship of the time slots between the radio terminals within one cycle, for example, in a case where the two radio relay terminals 201, 301 are present between the radio master terminal 101 and the radio slave terminals 302, 303 in the third hierarchy, and the three radio relay terminals 201, 301, 401 are present between the radio master terminal 101 and the radio slave terminal 402 in the fourth hierarchy, in the radio communication system of FIG. 2.

In the base slots 40 of FIG. 12, the lower slots 41 are depicted as “lower” and the upper slots 42 are depicted as “upper”. Number assigned to “upper” and “lower” and placed at upper side indicates each of the slot numbers of the base slots 40.

In the example of FIG. 12, in the radio master terminal 101, the radio relay terminals 201, 301, 401 and the radio slave terminals 302, 303, 402, one cycle is divided into 256 base slots 40. The base slots 40 are assigned with slot numbers from 1 to 256, respectively. Subsequently to the base slot 40 assigned with the final slot number 256, the base slot 40 assigned with the first slot number 1 is present.

Hereinafter, for easier description, the base slot 40 of the slot number X is expressed as “No. X-base slot 40.”

In the example of FIG. 12, from the radio master terminal 101 to the radio relay terminal 201, a beacon signal Bi in the first hierarchy is transmitted regularly. Also, from the radio relay terminal 201 to the radio relay terminal 301, a beacon signal Bii in the second hierarchy is transmitted regularly. Also, from the radio relay terminal 301 to the radio slave terminals 302, 303, and the radio relay terminal 401, a beacon signal Biii in the third hierarchy is transmitted regularly.

In FIG. 12, among the beacon signals Biii transmitted from the radio relay terminal 301, flow of the beacon signal Biii transmitted to the radio slave terminal 302 is indicated by solid line, and flow of the beacon signal Biii transmitted to the radio slave terminal 303 and the radio relay terminal 401 is indicated by broken line. Also, from the radio relay terminal 401 to the radio slave terminal 402, a beacon signal Biv in the fourth hierarchy is transmitted.

In FIG. 12, a signal indicated by arrows of C1 to C6 indicates a signal (participation request signal) transmitted when the radio terminal participates in the radio communication system as will be described later.

The lower devices are configured to receive the beacon signals Bi˜Biv transmitted from the upper devices to the lower devices once in every cycle. When a length of one cycle (cycle length) is T4, T4=256×T1 in the example of FIG. 12. For example, when T1=2 seconds, T4=512 seconds (8 minutes 32 seconds). The beacon signals Bi˜Biv are transmitted from the upper devices in cycles of once in every two beacon transmission slots (BT) 31. That is, the beacon signals Bi˜Biii are transmitted in cycles of once in every two base slots 40, and a transmission interval T5 of the beacon signals Bi˜Biii is T5=2×T1. For example, when T1=2 seconds, T5=4 seconds.

In FIG. 12, ordinal numbers of the beacon signals Bi˜Biii transmitted and received within one cycle are in parentheses. For example, in the case of the beacon signal Bii in the second hierarchy transmitted from the radio relay terminal 201 to the radio relay terminal 301, the first beacon signal Bii transmitted in No. 1-base slot 40 is depicted as “Bii(1)”, the second beacon signal Bii transmitted in No. 3-base slot 40 is depicted as “Bii(2)”, and the m-th beacon signal Bii transmitted in No. 255-base slot 40 is depicted as “Bii(m)”.

As described above, for example, the beacon signal transmitted from the radio master terminal 101 is received regularly by the radio relay terminal 201. In the radio communication system of Embodiment 1, the radio relay terminal 201 is configured to receive the beacon signal Bi(1) transmitted from the slot number 1 of the radio master terminal 101. The beacon signal Bi(1) transmitted from the slot number 1 contains information of beacon number 1. When the radio relay terminal 201 receives the beacon signal Bi(1) of the beacon number 1, it newly configures the slot so that a head position of the upper slot of the base slot number 255 of the radio relay terminal 201 is aligned with a head position of the lower slot of the base slot number 1 of the radio master terminal 101. The radio relay terminal 201 transmits the beacon signal in odd-number base slot number as in the radio master terminal 101. By similar operation, the lower device receives the beacon signal transmitted from the base slot number 1 of the upper device, and newly configures the slot of itself in synchronization with timing of the upper device. Since the interval at which the lower device receives the beacon signal from the upper device is once in every 256 base slots, the reception interval is 8 minutes 32 seconds.

### [Transmission Operation and Reception Operation of Beacon Signal]

Hereinafter, with reference to FIG. 13 in addition to FIG. 12, a description will be more specifically given of the transmission operation of the beacon signals Bi˜Biv from the upper devices to the lower devices and the reception operation of the beacon signals Bi˜Biv in the lower devices. FIG. 13 is a view showing an exemplary positional relationship between the time slots (base slots 40) of FIG. 10, which are managed in the radio terminals. FIG. 13 shows positional relationship similar to that of FIG. 12, except that each of the lower slot 41 and the upper slot 42 of each base slot 40 is depicted as three time slots of FIG. 10. For easier description, FIG. 13 shows the radio relay terminals 201, 301, among the radio relay terminals 201, 301, 401 of FIG. 12. Also, FIG. 13 shows only the radio slave terminal 302, among the radio slave terminals 302, 303, 402.

In the example of FIGS. 12 and 13, an uppermost radio terminal is the radio master terminal 101, and the beacon signal Bi in the first hierarchy is transmitted from the radio master terminal 101 to the lower device regularly in cycles of T5=2×T1. The upper device (radio master terminal 101) transmits the first beacon signal Bi(1) in the beacon transmission slot 31 included in the lower slot 41 of No. 1-base slot 40. The second beacon signal Bi(2) is transmitted to the lower device in No. 3-base slot 40, the third beacon signal Bi(3) is transmitted to the lower device in No. 5-base slot 40, and the fourth beacon signal Bi(4) is transmitted to the lower device in No. 7-base slot 40 (beacon signal Bi(4) is not shown in FIG. 13). Thereafter, the beacon signals Bi are transmitted sequentially from the base slots 40 of odd-number slot numbers. When the transmission order returns to No. 1-base slot 40 again, the first beacon signal Bi(1) is transmitted.

The lower device directly subordinated to the radio master terminal 101 is the radio relay terminal 201. The radio relay terminal 201 regularly receives the beacon signal Bi transmitted from the radio master terminal 101. The radio relay terminal 201 receives the beacon signal Bi once in every cycle. In the example of FIG. 12, every time the radio master terminal 101 transmits the first beacon signal Bi(1), the radio relay terminal 201 receives the beacon signal Bi(1) in the beacon reception slot 34 included in the upper slot 42 of the base slot 40. When the radio relay terminal 201 receives the beacon signal Bi (1), it aligns the slot position of No. 255-base slot 40 of the radio relay terminal 201 with the slot position of No. 1-base slot 40 of the radio master terminal 101.

Specifically, as shown in FIG. 13, the radio relay terminal 201 newly configures the time slot of itself so that a beacon reception slot 34 (BR in FIG. 13) which is a head position of the upper slot 42 of No. 255-base slot 40 corresponds to a beacon transmission slot 31 (BT in FIG. 13) which is a head position of the lower slot 41 of No. 1-base slot 40. That is, the radio relay terminal 201 synchronizes its clock such that the slot position of the beacon reception slot 34 of No. 255-base slot 40 is aligned with the slot position of the beacon transmission slot 411 of No. 1-base slot 40 of the radio master terminal 101.

In the example of FIG. 12, the time slots in which the beacon signals Bi˜Biv are received are represented by black color. That is, in the example of FIG. 12, the upper slots 42 of No. 255-base slots 40 of the lower device, are represented by black color. In the example of FIG. 13, the beacon reception slots 421 in which the lower device performs position alignment (clock synchronization) are represented by hatching.

The radio relay terminal 201 constitutes the first hierarchy together with the radio master terminal 101, and the like, and constitutes the second hierarchy together with the radio relay terminal 301, and the like (see FIG. 2). Therefore, the radio relay terminal 301 is the lower device directly subordinated to the radio relay terminal 201. The radio relay terminal 201 transmits the beacon signal Bii in the second hierarchy to the lower device in the base slot 40 of odd-number slot number. Among the beacon signals Bii of the radio relay terminal 201 which is the upper device, the radio relay terminal 301 receives the first beacon signal Bii(1) and newly configures the time slot of itself so that a slot position of No. 255-base slot 40 of the radio relay terminal 301 is aligned with a slot position of No. 1-base slot 40 of the radio relay terminal 201.

The radio relay terminal 301 constitutes the third hierarchy (see FIG. 2) together with the radio slave terminal 302, and the like. The radio relay terminal 301 transmits the beacon signal Biii in the third hierarchy to the radio slave terminal 302, in the base slot 40 of odd-number slot number, at intervals of T5. Like the radio relay terminal 201 and the radio relay terminal 301, the radio slave terminal 302 receives the first beacon signal Biii(1), and newly configures the time slot of itself so that a slot position of No. 255-base slot 40 of the radio slave terminal 331 is aligned with a slot position of No. 1-base slot 40 of the radio relay terminal 301.

In the examples of FIGS. 12 and 13, the lower device is configured to transmit the first beacon signal in slot position immediately before the upper device transmits the second beacon signal. In addition, instead of receiving the beacon signal and performing the above stated clock synchronization every time the upper device transmits the beacon signal in every odd-number slot number, the lower device receives the beacon signal transmitted from the upper device once in every cycle (T4) (receives the beacon signal once in every 56 base slots 40 in the example of FIG. 12), and performs clock synchronization.

In communication in the direction from the upper device to the lower device (lower-direction communication), the radio relay terminal awaits intermittent reception in the link connection slots 35 of all of the upper slots 42 (reception carrier sense operation) and awaits the radio signal from the upper device. By comparison, the upper device can transmit the radio signals for link connection in the link connection slots 32 of all of the lower slots 41, as well as the link connection slots 32 immediately after the upper device has transmitted the beacon signals. More specifically, the reception carrier sense operation is as follows. The radio relay terminal detects whether or not the reception level of the electric wave received from the upper device is equal to or higher than a specified level (first specified value or second specified value). If the reception level is lower than the specified level, the radio relay terminal does not perform radio communication and is in a standby state, whereas if the reception level is equal to or higher than the specified level, the radio relay terminal receives the link connection signal 50 as will be described later from the upper device.

In communication in the direction from the lower device to the upper device (upper-direction communication), when a need for communication arises, the lower device receives in the beacon reception slot 34 of the upper slot 42, the beacon signal transmitted from the upper device at a most recent time. The lower device aligns a timing of the following link connection slot 35 with a timing of the link connection slot 32 of the lower slot 41 of the upper device, and transmits the radio signal for link connection in the link connection slot 35. The upper device performs intermittent reception awaiting in the link connection slot 32 just after the upper device has transmitted the beacon signal.

### [Radio Slave Terminal Participates in Radio Communication System]

Next, a description will be given of an operation which occurs when the radio slave terminal 302 newly participates in the radio communication system. For example, as shown in FIG. 12, it is assumed that the radio communication system includes the radio master terminal 101, the radio relay terminal 201 and the radio relay terminal 301, and for example, the radio slave terminal 32 newly participates in the system having this configuration. When a power supply of the radio slave terminal 302 is turned ON, the radio slave terminal 302 performs a reception operation for a specified time. That is, the radio slave terminal 302 performs the reception operation of the beacon signal continuously for a period longer than the beacon transmission interval T5. This operation will be referred to as a search mode as shown in FIG. 12.

The radio master terminal 101 and the radio relay terminals 201, 301, 401 are configured to transmit the beacon signals once or more times without fail during the period of the search mode. In a case where the radio slave terminal 302 receives plural beacon signals within the period of the search mode, it decides a radio terminal as a connection target according to specified determination conditions and performs clock synchronization of itself. In this case, the specified determination conditions are the reception level of the received beacon signal and the relay stage number information of the radio relay terminal 201 which is a transmission source of the received beacon signal.

For example, in a case where the communication area is in a state of FIG. 1, the radio slave terminal 302 determines that the reception level of the beacon signal Biii transmitted from the radio relay terminal 301 and the reception level of the beacon signal Biv transmitted from the radio relay terminal 401 are equal to or higher than the second specified value. Then, the radio slave terminal 302 decides as the connection target the radio relay terminal 301 in which the relay stage number is smaller, of the radio relay terminal 301 and the radio relay terminal 401 in which the reception levels of the beacon signals are equal to or higher than the second specified value.

Then, the radio slave terminal 302 receives the beacon signal Biii in the third hierarchy from the radio relay terminal 301, performs synchronization of the clock with that of the radio relay terminal 301, and performs the link connection process by transmitting the link connection request signal 50 as will be described later to the radio relay terminal 301. For example, when the radio slave terminal 302 receives the beacon signal Biii in the beacon reception slot 34 in the upper slot 42 of No. X-base slot 40, it transmits the link connection request signal 50 in the lower calling slot 37 in the link connection slot 35 following the beacon reception slot 34. The radio slave terminal 302 receives a response signal which permits the link connection from the radio relay terminal 301 in the upper response/upper calling slot 38 following the lower calling slot 37. In this way, the radio link connection between the radio relay terminal 301 and the radio slave terminal 302 is established.

Then, the radio slave terminal 302 makes a request for relay to the radio relay terminal 301 by transmitting a participation request signal C1 to the radio relay terminal 301 in the upper slot of No. 253-base slot 40 so that the radio slave terminal 302 can be subordinated to the radio relay terminal 301. The radio slave terminal 302 transmits the participation request signal C1 in the data communication slot 36 following the link connection slot 35 (upper response/upper calling slot 38) in which the response signal is received when the radio link connection is established.

The participation request signal C1 includes a frame signal (network layer (layer 3) frame as will be described later) to be relay-transmitted to the final destination and the route information 87 from the radio slave terminal 302 to the radio master terminal 101. The final destination of the participation request signal C1 is the radio master terminal 101. Therefore, when the radio relay terminal 201 receives the participation request signal C1 from the radio slave terminal 302, it transmits a relay signal C2 which relays the participation request signal from the radio slave terminal 302, to the radio relay terminal 201 which is the upper device for the radio relay terminal 301.

When the radio relay terminal 201 receives the relay signal C2 from the radio relay terminal 301, it transmits a relay signal C3 which relays the participation request signal, to the radio master terminal 101. Receiving the relay signal C3, the radio master terminal 101 creates a participation permission signal based on the relay signal C3 which relayed the participation request signal C1 transmitted from the radio slave terminal 302, and transmits the participation permission signal to the radio slave terminal 302 via the relay signals C4, C5, C6. By the above described operation, the radio slave terminal 302 is subordinated to the radio relay terminal 301.

As described above, C1 to C6 which are the participation request signal, the participation permission signal and the relay signals, are transmitted and received using the data communication slots 33, 36 after the radio link connection is established using the link connection slots 32, 35 included in the base slots 40 of FIG. 10.

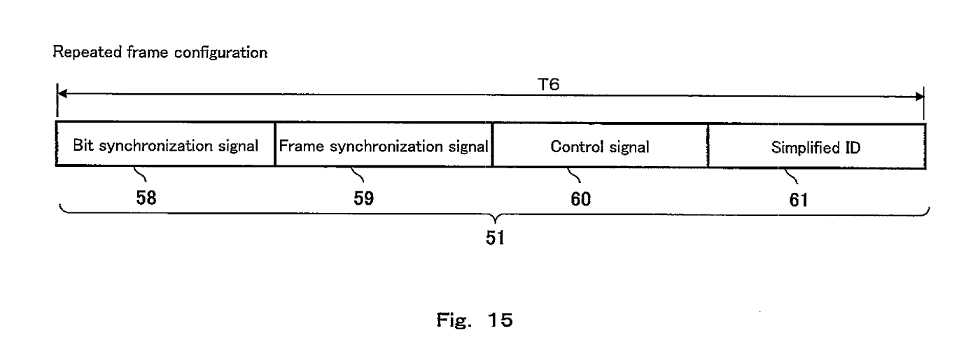

Now, the signal format of the link connection signal 50 transmitted and received in the link connection slot will be described with reference to FIGS. 14 and 15. FIG. 14 is a view showing an exemplary signal format of the link connection signal 50 transmitted between the radio terminals in the radio communication system according to Embodiment 1 of the present invention. FIG. 15 is a view showing an exemplary frame configuration of the repeated frame contained in the link connection signal 50 of FIG. 14.

As shown in FIG. 14, the link connection signal 50 is composed of n repeated frames 51 and a body frame 52. The n repeated frames 51 are assigned with frame numbers 1˜n, respectively. As shown in FIG. 15, one repeated frame 51 is composed of a bit synchronization signal 58, a frame synchronization signal 59, a control signal 60 and a simplified ID 61. A frame length of the repeated frame 51 is T6. Therefore, a frame length (repetition time) of the n repeated frames 51 is T7=n×T6.

The bit synchronization signal 58 constituting the repeated frame 51 is a signal used to decide a sampling position of a bit. The frame synchronization signal 59 is a signal used to detect a head of data contained in the repeated frame 51. The control signal 60 is a signal describing control information. The simplified ID 61 is a shortened form of an identification code (ID) used to identify a transmission source device. When a bit size of an original ID which is not shortened is 64 bits, the simplified ID 61 is information of 16 bits obtained by dividing the original ID in four. Alternatively, simplified ID 61 may be a shortened form of the identification code (ID) used to identify the transmission source device.

The control information described in the control signal 60 contains information relating to the simplified ID 61, the frame number of the repeated frame 51, etc. For example, the information relating to the simplified ID 61 indicates which of four divided portions of the original ID the simplified ID 61 is. The frame numbers assigned to the n repeated frames 51 are described in the control signal 60 as the control information. As shown in FIG. 14, the repeated frames 51 are transmitted in descending order of the frame number (maximum frame number is n), and the frame number of the repeated frame 51 just before the body frame 52 is 1.

As described above, to receive the link connection request signal transmitted between the upper device and the lower device, each radio terminal performs the reception carrier sense operation. In the reception carrier sense operation, consideration must be given to the fact that an internal clock (clock section) of the upper device and an internal clock (clock section) of the lower device are asynchronous.

For example, in a case where a maximum relative error between the clock of the upper device and the clock of the lower device is ±100 ppm and the lower device synchronizes the clock with that of the upper device at the beacon reception interval=8 minutes 32 seconds as described above, a clock difference of ±51.2 ms at maximum between the upper device and the upper device occurs. Therefore, by setting the number of times n of transmission of the repeated frames so that T7>=51.2 ms×2=102.4 ms, when the repeated frame length (repetition time) in the link connection signal 50 is T7, reception awaiting can be performed in the repeated frame 51 without fail. That is, failure to receive the link connection request signal can be avoided.

### (Data Communication Signal)

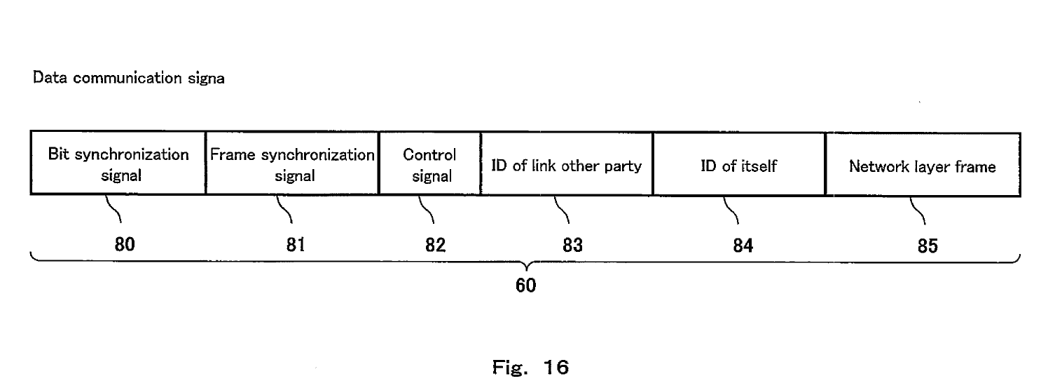

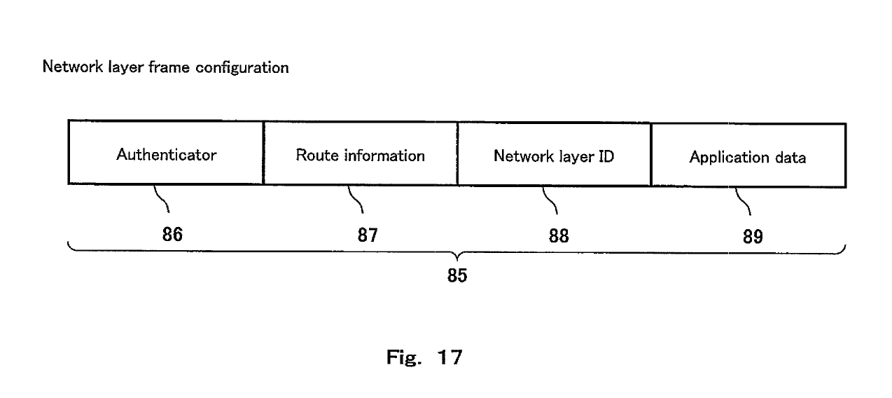

As described above, when the link connection is completed, the radio slave terminal 302 makes a request for a relay by transmitting the participation request signal C1 directed to the radio master terminal 101 which is the final destination, to the radio relay terminal 301 with which the link connection is established in the data communication slot 36 of FIG. 10. The format of the data communication signal 60 (e.g., participation request signal C1, etc.) transmitted and received in the data communication slot 36 between the upper device and the lower device is shown in FIGS. 16 and 17. FIG. 16 is a view showing an exemplary signal format of the data communication signal 60 transmitted and received between the radio terminals in the radio communication system according to Embodiment 1 of the present invention. FIG. 17 is a view showing an exemplary frame configuration of the network layer (layer 3) frame 85 contained in the data communication signal 60 of FIG. 16.

As shown in FIG. 16, the data communication signal 60 is composed of a bit synchronization signal 80, a frame synchronization signal 81, a control signal 82, a link other party ID 83, ID 84 of the radio terminal corresponding to this data communication signal 60, and a network layer (layer 3) frame 85.

The bit synchronization signal 80 is a signal used to decide a sampling position of a bit. The frame synchronization signal 81 is a signal used to detect a head position of data contained in the data communication signal 60. The control signal 82 is a signal describing control information. The control signal 82 also contains information of a signal length from a head of the link other party ID 83 to a tail of the network layer frame 85. Therefore, for example, in a case where the upper device receives the data communication signal 60 from the lower device, it analyzes the control signal 82 to know up to which portion of the data communication signal 60 should be received.

The link other party ID 83 is ID of other party to which the data communication signal 60 is transmitted, i.e., ID used to identify other party device with which the radio link connection is established. For example, in a case where the data communication signal 60 is transmitted from the radio slave terminal 302 to the radio relay terminal 301 which is the upper device for the radio slave terminal 302, the link other party ID 83 is ID of the radio relay terminal 301. The ID 84 corresponding to this data communication signal 60, is ID used to identify the device (transmission source device) which transmits the data communication signal 60. For example, in a case where the transmission source of the data communication signal 60 is the radio slave terminal 302, the ID 84 corresponding to this data communication signal 60, is ID used to identify the radio slave terminal 302.

The network layer frame 85 is a frame signal used to relay-transmit the data communication signal 60 to the final destination. That is, other signals and IDs of the data communication signal 60 are created according to a combination of the lower device and the upper device which transmit and receive the data communication signal 60 and transmitted. By comparison, the network layer frame 66 is transmitted from the radio slave terminal 302 as the transmission source (initial transmission source) to the radio master terminal 101 which is the final destination via the radio relay terminal 201 and the radio relay terminal 301.

As shown in FIG. 17, the network layer frame 66 is composed of an authenticator 86, route information 87, network layer ID 88, and application data 89.

The authenticator 86 is a code used to check whether or not the network layer frame 85 is an authorized frame data, at a reception side of the data communication signal 60.

The route information 87 is, for example, information of a relay route from the radio slave terminal 302 to the radio master terminal 101. More specifically, the route information 87 is information relating to the radio relay terminals (radio relay terminals 201, 301) which are present between the radio slave terminal 302 and the radio master terminal 101 and is incorporated into the network layer frame 85. The route information 87 is created by, for example, the radio relay terminals (radio relay terminals 201, 301) via which communication from the radio slave terminal 302 to the radio master terminal 101 is performed and is incorporated into the network layer frame 85.

The network layer ID 88 is ID of the radio terminal which is the transmission source of the data communication signal 60. For example, in a case where the transmission source of the data communication signal 60 is the radio slave terminal 302, the network layer ID is ID indicating the radio slave terminal 302.

The application data 89 is data relating to application which is to be transmitted to the radio terminal which is the final destination of the data communication signal 60.

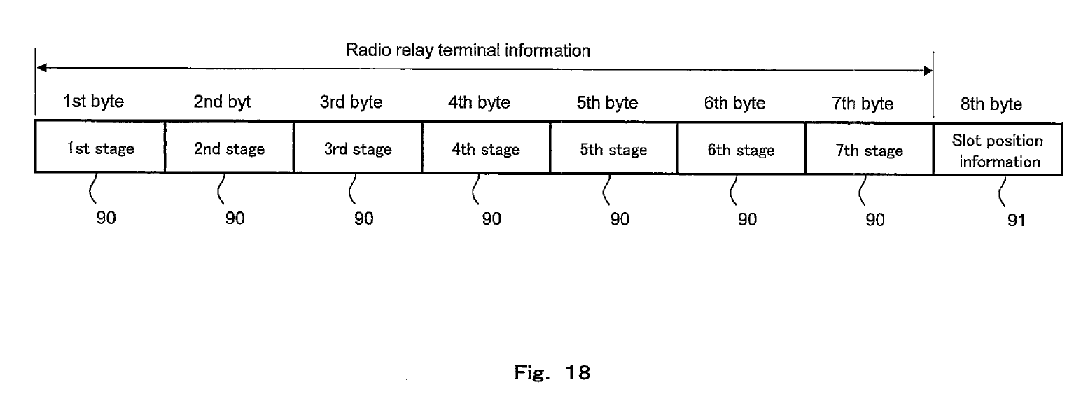

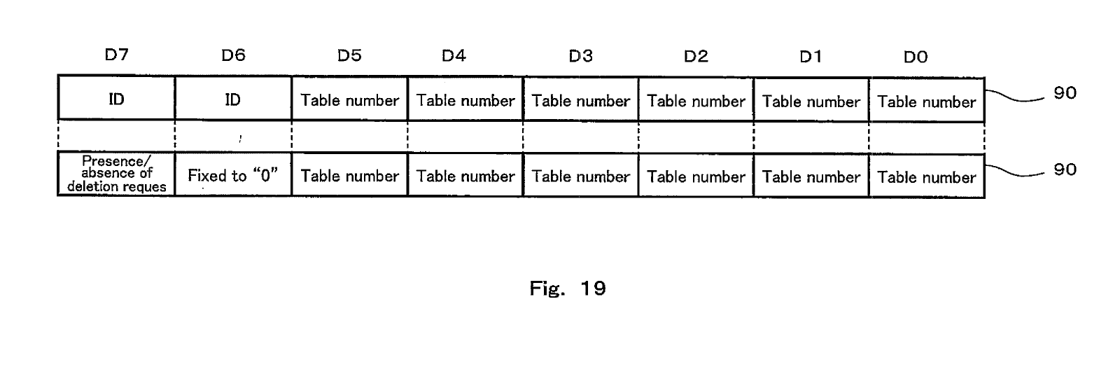

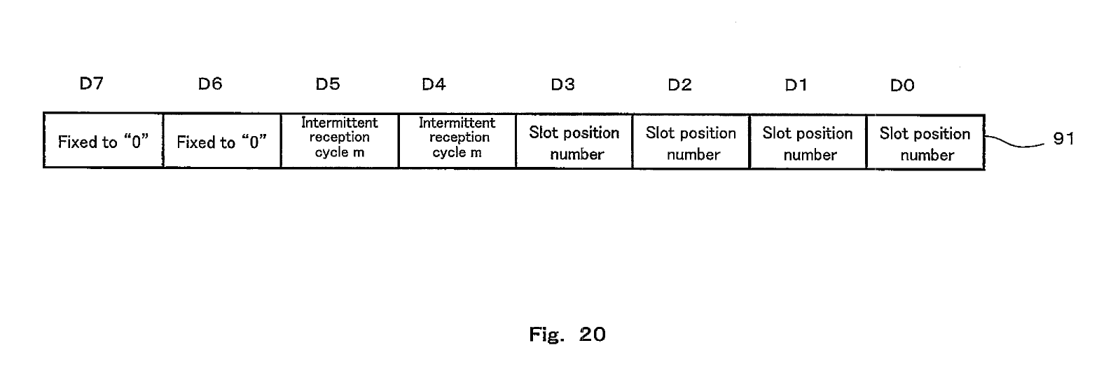

Next, the route information 87 contained in the network layer frame 66 will be described specifically with reference to FIGS. 18 to 20. FIG. 18 is a view showing an exemplary configuration of the route information 87 according to Embodiment 1 of the present invention. FIG. 19 is a view showing a bit configuration of the radio relay terminal information 90 contained in the route information 87 of FIG. 18. FIG. 20 is a view showing a bit configuration of slot position information contained in the route information 87 of FIG. 18.

As shown in FIG. 18, for example, the route information 87 is composed of 8 bytes. Information (radio relay terminal information 90) of the radio relay terminals 201, 301 which are present on the relay route from the radio slave terminal 302 to the radio master terminal 101 are stored in a range of 1st byte to 7th byte. The slot position information 19 is stored in 8th byte.

For example, in the radio communication system in which the radio master terminal 101 is the uppermost device, the radio slave terminal 302 is the lowermost device, and the radio relay terminals 201, 301 are present between the radio master terminal 101 and the radio slave terminal 302, the radio slave terminal 302 transmits the data communication signal 60 to the radio relay terminal 301 to which the radio slave terminal 302 is subordinated, i.e., the radio relay terminal 301 which is a connection target with which the radio slave terminal 302 should establish direct communication. Information of 8 bits relating to the radio relay terminals 201, 301 present on the relay route from the radio slave terminal 302 which is the transmission source of the data communication signal to the radio master terminal 101 which is the final destination of the data communication signal 60 is stored in the radio relay terminal information 90 of the route information 87. Herein, information relating to the two radio relay terminals which are the radio relay terminals 201, 301 is stored as the radio relay terminal information 90 in first and second stages of the route information 87. It should be noted that the route information 87 is able to store the radio relay terminal information 90 up to 7 stages at maximum.

Now, the bit configuration of the radio relay terminal information 90 will be specifically described. As shown in FIG. 19, a portion of the bit information is different between a case where the route information 87 is transmitted from the upper device to the lower device and a case where the route information 87 is transmitted from the lower device to the upper device.

The radio relay terminal information 90 shown at the upper side of FIG. 19 corresponds to the case where it is transmitted from the lower device to the upper device. Data bit D7 of the radio relay terminal information 90 is an identifier used to identify whether or not a table to be managed by the radio relay terminal in each stage such as the radio relay terminal 201 has reached a limit. That is, the radio relay terminal (e.g., radio relay terminal 201) is configured to manage the radio relay terminal (e.g., radio relay terminal 301) which is the lower device directly subordinated to itself, by means of the table. It is indicated whether or not the number of the lower radio relay terminals to be managed by the radio relay terminal has reached the upper limit, using the identifier.

By comparison, the radio terminal information 90 shown at the lower side of FIG. 19 corresponds to the case where it is transmitted from the upper device to the lower device. Data bit D7 of the radio relay terminal information 90 indicates whether or not there is a deletion request of a table number owned by the radio relay terminal in each stage, such as the radio relay terminal 201. The radio master terminal 101 makes this deletion request to the radio relay terminal which is the lower device for itself. That is, the table owned in the radio relay terminal is configured such that the table number corresponds to ID of the radio relay terminal (lower device) to be managed. It can be identified by the identifier whether or not to delete the table number in response to the request from the radio master terminal 101 and exclude the particular radio relay terminal 201 (lower device) from the radio relay terminals to be managed.

Data bit D6 of the radio relay terminal information 90 shown at the upper side is an identifier used to identify whether or not the corresponding radio relay terminal is registered for the first time (initially) in the table in a state in which the radio relay terminal (lower device) directly subordinated is not registered in the table yet. On the other hand, data bit D6 of the radio relay terminal information 90 shown at the lower side is fixed to “0”.

In each of the radio relay terminal information 90 at the upper side and the radio relay terminal information 90 at the lower side, table numbers indicating the radio relay terminals (lower devices) to be managed by the radio relay terminals which are present in the relay route are stored in data bits D5˜D0. In Embodiment 1, table number which can be managed is up to “63”. That is, except for the table number “0”, 63 radio relay terminals from the table number “1” to “63” can be managed.

More specifically, for example, in the case of the system including the radio master terminal 101, the radio relay terminal 201 which is the lower device for the radio master terminal 101, the radio relay terminal 301 which is the lower device for the radio relay terminal 201, and the radio slave terminal 302 which performs communication with the radio master terminal 101 via the radio relay terminal 301 and the radio relay terminal 201, the route information 87 contains information as described below. The table number of the radio relay terminal 201 is stored in 1st byte of the route information 87. The table number of the radio relay terminal 301 is stored in 2nd byte of the route information 87. The table number “0” is stored in 3rd byte of the route information 87. This is because no radio relay terminal exists as the lower device for the radio relay terminal 301. In 4th byte and the following bytes of the route information 87, the table number “0” is stored.

In other words, when the radio communication system is constructed as w (w: natural number) hierarchies, the number of the radio relay terminals (i.e., relay stage number) included in the radio communication system is w. Therefore, the table numbers of 1st to (w−1)-th stage radio relay terminals are stored in 1st to (w−1)-th bytes, among 1st to 7th bytes of the route information 87. The table number of the w-th stage radio relay terminal is stored in w-th byte. The w-th stage radio relay terminal is the lowermost relay terminal and does not require a table number. Therefore, “0” is stored as the table number.

The radio relay terminal information 90 is stored in 1st byte to 7th byte of the route information 87, while the slot position information 91 is stored in 8th byte of the route information 87. The slot position information 91 means a slot number (slot position) in which, for example, the radio slave terminal 302 as the transmission source of the data communication signal 60 awaits reception of the radio signal from the radio relay terminal 301 immediately above the radio slave terminal 302. As described above, the radio slave terminal performs the reception carrier sense operation, in a skip manner, to reduce electric power consumption. To this end, the slot position information 91 in which the radio slave terminal performs the reception carrier sense operation is stored in 8th byte. A size of the slot position information 91 is 8 bits.

A bit configuration of the slot position information 91 will be specifically described. As shown in FIG. 20, unlike the radio relay terminal information 90, the bit configuration of the slot position information 91 is basically the same between the case where the route information 87 is transmitted from the upper device to the lower device and the case where the route information 87 is transmitted from the lower device to the upper device.

Specifically, in the slot position information 91, data bit D7 and data bit D6 are fixed to “0”. Also, data bit D5 and data bit D4 indicate intermittent reception cycle m of the lower device. The intermittent reception cycle m refers to a cycle in which the lower device performs the reception carrier sense operation with respect to the upper device. For example, in a case where the lower device is the radio relay terminal 201, normally, it performs the reception carrier sense operation in every base slot 40, and therefore the intermittent reception cycle m=1. By comparison, in the case of the radio slave terminal 302 which performs the reception carrier sense operation once in every two base slots 40, the intermittent reception cycle m=2.

In a case where the route information 87 is transmitted from the upper device to the lower device, the intermittent reception cycle m of the data bit D5 and the data bit D4 indicates “the intermittent reception cycle m of the lower device which is the final destination from the perspective of the upper device”. By comparison, in a case where the route information 87 is transmitted from the lower device to the upper device, the intermittent reception cycle m of the data bit D5 and the data bit D4 indicates “the intermittent reception cycle m of the lower device which is a calling source”.

Data bits D3˜D0 of the slot position information 91 indicate slot position number x in which center polling is performed. The slot position number x in which center polling is performed means, for example, slot position number x of the radio slave terminal 302 which is intermittently awaiting reception of the radio signal from the radio relay terminal 301 which is the upper device (performing the reception carrier sense operation). The slot position number x indicates (x−1)-th reference slot 40 which is from a reference slot number as defined below. x is in a range of 1 to the intermittent reception cycle m. The reference slot number is defined by the following formula (1). In formula (1), A is any one of integers from 0 to a value derived by dividing slot number 255 (i.e., n−1) by the intermittent reception cycle m (i.e., any one of integers of A=0˜(n−1)/m).

Reference slot number=A×m+1 (1)

More specifically, the reference slot number is slot number 1, slot number m+1, slot number 2 m+1, slot number 3 m+1 . . . , as shown in FIG. 12, and exists for every m slots. Therefore, the awaiting slot number y, i.e., the slot number of the base slot 40 corresponding to an actually reception awaiting state is represented by the following formula (2). x is any one of integers 1 to m as described above.

Awaiting slot number y=reference slot number+slot position number (x−1) (2)

When the radio master terminal 101 receives two information which are the intermittent reception cycle m and the slot position number x of the radio slave terminal 302, it creates a table of the route information 87 from the radio master terminal 101 to the radio slave terminal 302. As a value of the intermittent reception cycle m, a value common to the radio terminals constituting the radio communication system is desirably used, but the value may be different for each of the radio slave terminals 302. The slot position number x can be set as desired in each radio slave terminal 302. For example, the route information 87 created by the radio slave terminal 302 contains only the slot position information 91 in 8th byte because no radio relay terminal intervenes at that point of time, and therefore, “0x00” is inserted into the radio relay terminal information 90 from 1st byte to 7th byte.

As should be understood from above, the advantage provided by the fact that the radio slave terminal 302 decides the slot position when it participates in the radio communication system is as follows. That is, after the radio slave terminal 302 transmits the participation request signal C1 to the radio master terminal 101, it can decide by itself the intermittent reception awaiting slot in which the participation permission signal from the radio master terminal 101 in response to the participation request signal C1, i.e., the participation permission signal C6 transmitted from the radio relay terminal 301, is received. Because of this, the radio slave terminal 302 can await in a standby state until time reaches the intermittent reception awaiting slot decided by itself.

The radio slave terminal manages only the slot position information of the radio relay terminal to which that radio slave terminal is subordinated, in the route information 87. For example, the radio slave terminal 302 manages only the slot position information of the radio relay terminal 301 to which it is subordinated, in the route information 87.

The radio relay terminal manages only the radio relay terminal directly subordinated to itself, by means of the table such that the table number corresponds to the radio relay terminal which is directly subordinated to itself. For example, the radio relay terminal 201 manages only the radio relay terminal 301 directly subordinated to itself, by means of the table, in the route information 87.

The radio master terminal 101 manages the slot position information of the radio slave terminal and the table number information of the radio relay terminal(s) present on a route up to this radio slave terminal, by means of the route information table. For example, in a case where the radio master terminal 101 preserves the route information 87 up to the radio slave terminal 302, this route information contains the slot position information of the radio slave terminal 302, and the table number information corresponding to the radio relay terminals 201, 301 present on the route up to the radio slave terminal 302.

Now, transmission and reception of the data communication signal 60, including the route information 87, will be specifically described in conjunction with the flow of the signals C1 to C6 of FIG. 12.

Initially, the radio slave terminal 302 transmits the participation request signal C1 as the data communication signal 60, to the radio relay terminal 301. The route information 87 created by the radio slave terminal 302 is incorporated into the data communication signal 60 (participation request signal C1) and transmitted to the radio relay terminal 301. Receiving the data communication signal 60 (participation request signal C1) from the radio slave terminal 302, the radio relay terminal 301 analyzes the route information 87 contained in the data communication signal 60. Specifically, the radio relay terminal 301 analyzes a byte corresponding to an ordinal-number stage of itself, in the route information 87. Since the radio relay terminal 301 is the second stage from the perspective of the radio master terminal 101, it analyzes a 2nd byte (see FIG. 18) in the route information 87. If a result of the analysis is “0x00”, the radio relay terminal 301 interprets that the data communication signal 60 (participation request signal C1) is a relay request from any one of the radio slave terminals 302 to 304 subordinated to itself. On the other hand, if a result of the analysis is “0xFF”, the radio relay terminal 301 interprets that the transmission source of the data communication signal 60 is the radio relay terminal 401 subordinated to itself.

If the radio relay terminal 301 interprets that there is a relay request from any one of the radio slave terminals 302 to 304, it sets table number “0” in a byte corresponding to an ordinal-number stage in which it lies. Since the radio relay terminal 301 is in the second stage as described above, it sets table number “0” in data bits D5 to D0 corresponding to 2nd byte (see upper side in FIG. 19). In the example shown in FIG. 12, since there is a relay request from the radio slave terminal 302, the radio relay terminal 301 sets table number “0” in data bits D5 to D0 in the radio relay terminal information 90 of 2nd byte as described above. In addition, the radio relay terminal 301 sets “0xFF” in a byte corresponding to an ordinal-number stage which is one-ordinal-number upper than the ordinal-number stage in which the radio relay terminal 301 lies.

If a result of the analysis is “0xFF”, the radio relay terminal 301 interprets that there is a relay request from the radio relay terminal 401 and sets table number corresponding to the radio relay terminal 401 in data bits D5 to D0 in the radio relay terminal information 90 of a byte (2nd byte) corresponding to an ordinal-number stage in which the radio relay terminal 301 lies. If the radio relay terminal information 90 of the radio relay terminal 401 does not exist in the table managed by the radio relay terminal 301, the radio relay terminal 301 registers the radio relay terminal information 90 of the radio relay terminal 401 in this table, and sets the registered table number in the data bits D5 to D0 in the radio relay terminal information 90 of the byte corresponding to the ordinal-number stage in which the radio relay terminal 301 lies.

The route information analyzed and created by the radio relay terminal 301 is incorporated into the data communication signal 60 and transmitted to the radio relay terminal 201. As in the radio relay terminal 301, the radio relay terminal 201 analyzes and creates the route information. Since the radio relay terminal 201 lies in the first stage, it analyzes the radio relay terminal information 90 of 1st byte. In this case, if the 1st byte in the route information 87 is “0xFF”, the radio relay terminal 201 interprets that there is a relay request from the radio relay terminal 301 among the lower devices subordinated to the radio relay terminal 201. Then, the radio relay terminal 201 sets the table number corresponding to the radio relay terminal 301 in data bits D5˜D0 in a byte (1st byte in the route information 87) corresponding to an ordinal-number stage in which the radio relay terminal 201 lies.

The route information 87 analyzed and created by the radio relay terminal 201 is incorporated into the data communication signal 60 and transmitted to the radio master terminal 101.

The radio master terminal 101 analyzes the route information 87 and thus can confirm the relay route up to the radio slave terminal 302. The table number corresponding to ID of the radio relay terminal 301 managed by the radio relay terminal 201 is stored in 1st byte of the route information 87, and table number “0” is stored in 2nd byte of the route information 87. This enables the radio master terminal 101 to know which of the radio slave terminals 302 to 304 as the lower devices for the radio relay terminal 301, the transmission source of the data communication signal 60 is.

Furthermore, the intermittent reception cycle m and the slot position number x of the radio slave terminal 301 which is the transmission source is stored in 8th byte of the route information 87. Also, the ID of the radio slave terminal 302 which is the transmission source is known from the network layer ID 85.

In the above described manner, the radio master terminal 101 can know the route information 87 up to each of all of the radio slave terminals in, for example, the radio communication system of FIG. 2, from the route information 87 contained in the data communication signal 60 (participation request signal C1) transmitted to the radio master terminal 101 when the slave radio terminal newly participates in the system, and create the table of the route information 87.

That is, the radio master terminal 101 can know the relay route up to the radio slave terminal from the data communication signal 60 transmitted from the radio slave terminal. At a time point when the radio slave terminal newly participates in the radio communication system, the data communication signal 60 is transmitted to the radio master terminal 101. Therefore, the radio master terminal 101 can confirm the relay route by first communication without a need for relay transmission (relay communication) performed many times between the radio master terminal 101 and the radio slave terminal. Since the route information 87 contained in the data communication signal 60 has the above described configuration, the radio master terminal 101 can appropriately know the relay route by analyzing the route information 87.

### [Transmission of Polling Signal]

Next, a description will be specifically given of data communication performed between the radio terminals in the radio communication system of Embodiment 1, using as an example a case where the radio master terminal 101 transmits polling data to the radio slave terminal 302.

Specifically, for example, a description will be given of a case where the radio master terminal 101 transmits a polling signal to the radio slave terminal 302, in the system having the tree structure of FIG. 2.

If a transmission request of the polling signal to, for example, the radio slave terminal 302 occurs, the radio master terminal 101 creates the route information 87 including the relay route up to the radio slave terminal 302, the intermittent reception cycle m and the slot position number x of the radio slave terminal 302, with reference to the route information table owned by the radio master terminal 101. Then, the radio master terminal 101 incorporates this route information 87 into the network layer (layer 3) frame 66 of the polling signal (data communication signal 60).

Next, the radio master terminal 101 transmits the link connection signal 50 to the radio relay terminal 201, in the upper response/upper calling slot 38 in the link connection slot 32 of the lower slot 41. The radio relay terminal 201 is performing the reception carrier sense operation in all of the upper slots 42 (to be precise, upper response/upper calling slots 38). Because of this, if the reception level of the link connection signal 50 received from the radio master terminal 101 is equal to or higher than the first specified value, the radio relay terminal 201 can receive the link connection signal 50, in any of the upper slots 42. In this way, connection between the radio master terminal 101 and the radio relay terminal 201 can be established.

Thereafter, the radio relay terminal 201 receives the polling signal (data communication signal 60) transmitted from the radio master terminal 101, in the data communication slot 36 of the upper slot 42, confirms the network layer ID 88 contained in the network layer frame 66 of the polling signal, and determines whether or not the polling signal is directed to the radio relay terminal 201. If the radio relay terminal 201 determines that the polling signal is not directed to itself, it determines that there is a relay request and analyzes 1st byte (see FIG. 18) of the route information 87.

In a case where the table number stored in the data bits D5 to D0 of 1st byte is “0” as a result of the analysis of the route information 87 which is performed by the radio relay terminal 201, this means that the received polling signal is directed to any one of the radio slave terminals 202 to 204 directly subordinated to the radio relay terminal 201. However, this polling signal is directed to the radio slave terminal 302 which is a lower radio terminal relative to the radio slave terminals 202 to 204. Therefore, the table number written in D5 to D0 bits of 1st byte is the table number corresponding to the ID of the radio relay terminal 301. Therefore, the radio relay terminal 201 knows the ID of the radio relay terminal 301 which is a next relay target, with reference to the table owned by the radio relay terminal 201, based on the table number stored in the data bits D5 to D0 of 1st byte. Then, the radio relay terminal 201 performs the link connection with the radio relay terminal 301 according to the same procedure as that in the case of the radio master terminal 101. If the reception level of the link connection signal 50 received from the radio relay terminal 201 is equal to or higher than the second specified value, the radio relay terminal 301 receives this link connection signal 50, and establishes connection with the radio relay terminal 201. When the connection between the radio relay terminal 201 and the radio relay terminal 301 is established in this way, the radio relay terminal 201 relay-transmits the polling signal to the radio relay terminal 301.

As in the case of the radio relay terminal 201 as described above, the radio relay terminal 301 analyzes the polling signal received from the radio relay terminal 201. That is, the radio relay terminal 301 confirms the table number written in D5 to D0 bits of 2nd byte of the route information 87 included in the polling signal. Since the table number written in the data bits D5 to D0 of 2nd byte is “0” in this case, the radio relay terminal 301 knows that the received polling signal is directed to any one of the radio slave terminals 302 to 304 directly subordinated to the radio relay terminal 301.

As to which of the radio slave terminals 302 to 304 subordinated to the radio relay terminal 301, the poling signal is directed, can be known from the network layer ID 88 contained in the polling signal (data communication signal 60). In this case, ID of the radio slave terminal 302 which is the final destination is written in the network layer ID 88.

Furthermore, the radio relay terminal 301 analyzes the slot position information 91 of 8th byte of the route information 87, to know the intermittent reception cycle m and the slot position number x of the radio slave terminal 302. As described previously, the radio relay terminal 301 calculates the slot in which the radio slave terminal 302 is performing the intermittent reception awaiting based on the intermittent reception cycle m and the slot position number x. Then, according to the calculated slot, the radio relay terminal 301 transmits the link connection signal 50, and performs link connection with the radio slave terminal 302. When the connection between the radio relay terminal 301 and the radio slave terminal 302 is established, the radio relay terminal 301 relay-transmits the polling signal (data communication signal 60) to the radio slave terminal 302.

The data stored in the network layer frame 85, which is the data created in the radio master terminal 101, is transmitted to the radio slave terminal 302, without being changed in the radio relay terminal 201 and the radio relay terminal 301. This allows the radio slave terminal 302 to receive application data 89 existing in the network layer frame transmitted from the radio master terminal 101, without no change made to the application data 89.

In Embodiment 1, the slot number of the base slot 40 corresponding to the intermittent reception timing in the radio slave terminal is incorporated into the radio signal by the radio slave terminal and transmitted therefrom, in communication with the radio master terminal. Therefore, for example, the radio relay terminal 201 has only to own the table for managing only the radio relay terminal 301 (lower device) directly subordinated to itself, and need not own any information of the radio slave terminals (radio slave terminals 202 to 204) directly subordinated to itself. Therefore, the radio relay terminal (e.g., radio relay terminal 201) according to Embodiment 1 need not limit the number of the radio slave terminals (radio slave terminals 202 to 204) directly subordinated to itself, and thus is enabled to perform a relay for more radio slave terminals than the conventional radio communication system. In other words, the radio relay terminal of the present embodiment makes it possible to reduce a size (data volume) of the table owned by itself, assuming that it performs a relay for the radio slave terminals as many as those in the conventional radio communication system.

In addition, the radio master terminal makes it possible to reduce a data volume of the route information table containing the route information from the radio master terminal to the radio slave terminal. For example, the radio master terminal 101 may be configured as follows. The radio master terminal 101 needs to manage the ID of the radio relay terminal 201 directly subordinated to itself. But, instead of directly managing the ID of the radio relay terminal 301 which is not directly subordinated to the radio master terminal 101, the radio master terminal 101 may manage the table number of the radio relay terminal 301 managed by the radio relay terminal 201. For example, assuming that the maximum number of the radio relay terminals which can be managed by each radio relay terminal is 63, the number of tables necessary in each radio relay terminal, i.e., IDs of the radio relay terminals to be managed are 63. The table numbers corresponding to these IDs can be adequately represented by 6-bit information. Therefore, 64-bit information is managed using by 6-bit information for one radio relay terminal.

Furthermore, since the route information 87 incorporated into the data communication signal 60 is not the ID of the radio relay terminal of the relay route, but is the table number corresponding to this ID, number of bytes of the route information can be reduced. For example, assuming that the maximum number of the radio relay terminals which can be managed by each radio relay terminal is 63, one-stage relay route can be set using 6-bit information. In general, ID for identifying the radio terminal requires many number of bits, for example, 64 bits. Therefore, in a method in which the ID of the radio relay terminal on the relay route is transmitted as the route information 87, the volume of the route information 87 is tremendous, which results in a waste in communication. On the other hand, in the method of Embodiment 1, in which the table number is transmitted as the route information 87, the volume of the route information 87 can be reduced, which enables efficient communication.

Although in Embodiment 1, the radio master terminal 101 stores and manages the slot position information of the radio slave terminal, the radio relay terminal may manage the slot position information of the radio slave terminal. Such a configuration causes an increase in the data volume of the table of the radio relay terminal, but has an advantage that the slot position information of 8th byte of the route information 87 is omitted.

Although in the present embodiment, it is presupposed that three kinds of radio terminals which are the radio master terminal, the radio relay terminals and the radio slave terminals are provided, it may be said that the radio relay terminal is a radio master terminal to the radio slave terminal, when considering a relationship between only the radio slave terminal and the radio relay terminal.

### Embodiment 2

When the radio terminal is newly placed in the radio communication system, the above mentioned “connection target deciding process” is performed to decide the connection target for the radio terminal newly placed. After the radio terminal which is the connection target is decided, connection with the radio terminal decided as the connection target is established, and the participation request signal is transmitted toward the radio master terminal 101. When the radio terminal newly placed receives the participation permission signal in response to the participation request signal, from the radio master terminal 101, it can participate in the radio communication system.

After the radio terminal has participated in the radio communication system, a situation surrounding this radio terminal changes in some cases, for example, an obstacle such as a building is constructed between this radio terminal and the radio master terminal or the radio relay terminal to which this radio terminal is subordinated. If the situation changes in this way, the reception level of the beacon signal received from the radio master terminal or the radio relay terminal to which this radio terminal is subordinated might be lowered. Accordingly, in Embodiment 2, the lower device such as the radio slave terminal or the radio relay terminal is able to address such a situation.

For example, it is assumed that the radio slave terminal 302 of FIG. 1 is newly placed in the radio communication system. At this time, the radio slave terminal 302 decides as the connection target the transmission source of the beacon signal in which the reception level is equal to or higher than the second specified value and the relay stage number is smallest, from among the received beacon signals. In the example of FIG. 1, the connection target for the radio slave terminal 302 is the radio relay terminal 301. The radio slave terminal 302 stores the reception level of the beacon signal received from the radio relay terminal 301 as reception level A, in a reception level storage section 1005 as will be described later. That is, when deciding the connection target, the radio slave terminal 302 stores as the reception level A, the reception level of the beacon signal received from the radio terminal which is the connection target (radio relay terminal 301). After the radio slave terminal 302 has participated in the radio communication system, the radio relay terminal 301 which is the connection target regularly transmits the beacon signal to the radio slave terminal 302. The reception level of the beacon signal regularly received in the radio slave terminal 302 from the radio relay terminal 301 changes in each reception due to an influence of a fading, etc. However, so long as there is no factor which constantly impedes transmission of the beacon signal, for example, an obstacle such as a building is constructed between the radio slave terminal 302 and the radio relay terminal 301, a median reception level value of the beacon signal received in the radio slave terminal 302 does not substantially change. The reception median value refers to a value located at a middle when the beacon signals received, for example, 10 times, in the radio slave terminal 302 from the radio relay terminal 301, are arranged in ascending order of reception level.

Conversely, if an obstacle exists between the radio slave terminal 302 and the radio relay terminal 301, the reception median value of the beacon signal received in the radio slave terminal 302 significantly changes. Therefore, the radio slave terminal 302 according to Embodiment 2 determines that there has been a significant change in the situation, for example, a building is built, after it newly participated in the radio communication system, if a reception level B of the beacon signal regularly received is lowered from the above stated reception level A by a specified level C or more. Then, the radio slave terminal 302 performs the “connection target deciding process” to newly decide the connection target, and newly performs an operation for participating in the radio communication system. The operation for newly participating in the radio communication system will be referred to as a new participation operation.

As should be appreciated from above, the lower device (radio relay terminal or radio slave terminal) of Embodiment 2 is different from the lower device (radio relay terminal or radio slave terminal) of Embodiment 1 in that the lower device of Embodiment 2 can decide the new connection target and perform the new participation operation. In addition, the new participation operation performed by the lower device (radio relay terminal or radio slave terminal) of Embodiment 2 is different from an initial participation operation to the radio communication system in that the “new connection target deciding process” for deciding the new connection target is performed.

### [Configuration of Radio Terminal]

Hereinafter, the configurations of the radio terminals (radio master terminal, radio slave terminal, and radio relay terminal) according to Embodiment 2 will be described. Since the main components of the radio terminal serving as the radio master terminal of Embodiment 2 of the present invention are the same as those of the radio master terminal 101 of FIG. 4, they will not be shown and described. In the same manner, since the main components of the radio terminal serving as the radio relay terminal of Embodiment 2 of the present invention are the same as those of the radio relay terminal 201 of FIG. 5, they will not be shown and described. Also, in the same manner, since the main components of the radio terminal serving as the radio slave terminal of Embodiment 2 of the present invention are the same as those of the radio slave terminal 102 of FIG. 6, they will not be shown and described. However, the configuration of the beacon reception section 14 of the radio relay terminal 201 of Embodiment 2 and the configuration of the beacon reception section 23 of the radio slave terminal 102 of Embodiment 2 are different from that of the radio relay terminal 201 of Embodiment 1 and that of the radio slave terminal 102 of Embodiment 1, respectively.

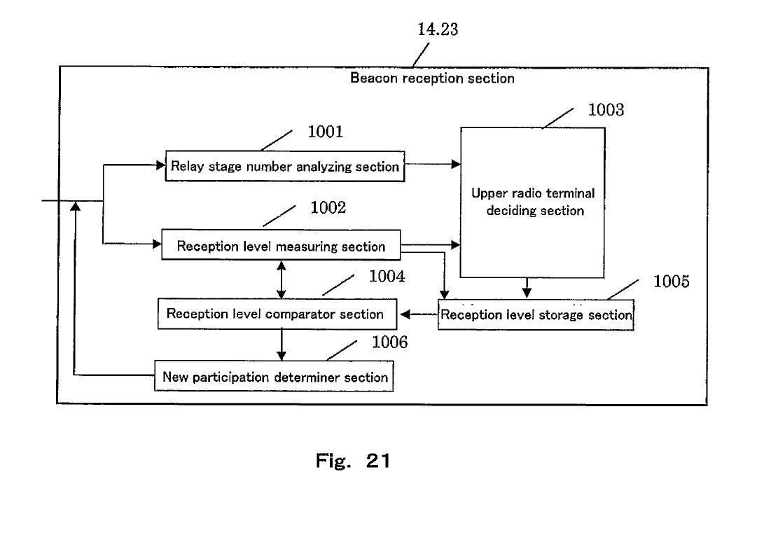

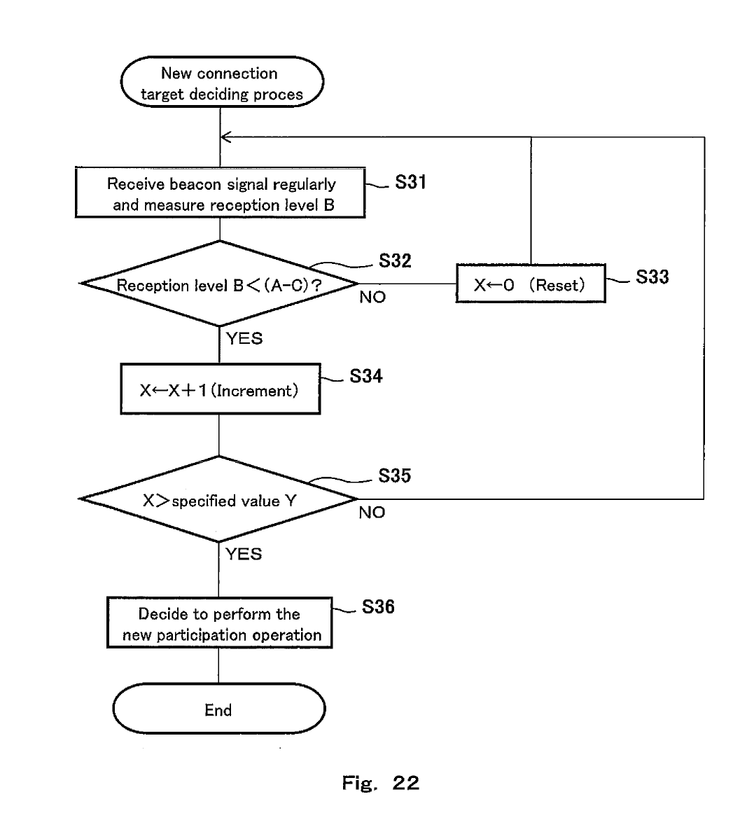

The configuration of the beacon reception section 14, 23 will be described with reference to FIG. 21. FIG. 21 is a block diagram showing an exemplary configuration of major components of the beacon reception section 14, 23 included in the radio relay terminal 201 or the radio slave terminal 102 according to Embodiment 2 of the present invention.

As shown in FIG. 21, the beacon reception section 14, 23 includes the relay stage number analyzing section 1001, the reception level measuring section 1002, the upper radio terminal deciding section 1003, a reception level comparator section 1004, a reception level storage section 1005, and a new participation determiner section 1006.

The beacon reception section 14, 23 of Embodiment 2 is different from the beacon reception section 14, 23 of Embodiment 1 in that it further includes the reception level comparator section (reception level determiner unit) 1004, the reception level storage section 1005, and the new participation determiner section (new connection target deciding unit) 1006. In addition, Embodiment 2 is different from Embodiment 1 in that when the reception level measuring section 1002 firstly decides the connection target for the radio terminal, it stores in the reception level storage section 1005, the reception level of the beacon signal received from this connection target, as the reception level A. Furthermore, Embodiment 2 is different from Embodiment 1 in that the reception level measuring section 1002 measures the reception level regularly received from the connection target, and the notifies reception level comparator section 1004 of the measured reception level.

The reception level comparator section 1004 determines whether or not the reception level B of the beacon signal regularly received is lower than a value which is derived by subtracting the specified level C from the above stated reception level A. The specified level C may be a predetermined value. The specified level C may be a fixed value or a variable value decided depending on the value of the reception level A. For example, the specified value C may be a variable value decided depending on the value of the reception level A in such a manner that when the reception level A is −70 dBm, the specified level C is 30 dB, while when the reception level A is −80 dBm, the specified level C is 25 dB. When the specified value C is the variable value in this way, table information indicating a correspondence between the reception level A and the specified level C is preserved in advance. It should be noted that the specified level C is suitably decided in a range lower than a level at which any negative effect is more likely to arise, for example, communication will discontinue, if the reception level is lowered from the reception level A by the specified level C or more.

In a case where the set reception level A is high, an adequate reception level which does not cause any trouble in communication can be ensured, even when the value of the reception level B of the beacon signal regularly received is somewhat lowered from the value of the reception level A, due to a situation change attributed to a fading etc. On the other hand, in a case where the set reception level A is low, communication will be negatively affected even when the value of the reception level B of the beacon signal regularly received is a little lowered from the value of the reception level A. Therefore, the specified level C is set to a variable value decided depending on the magnitude of the reception level A such that when the reception level A is high, the specified level C is made high. In this way, even when a situation somewhat changes, i.e., the reception level is somewhat lowered, the new participation operation will not occur.

The reception level storage section 1005 stores the value of the reception level A measured by the reception level measuring section 1002. The reception level storage section 1005 is a readable and writable storage medium.

The new participation determiner section 1006 determines whether or not the radio slave terminal 102 or the radio relay terminal 201 should perform the new participation operation for participating in the radio communication system, based on a result of the comparison performed by the reception level comparator section 1004. If the new participation determiner section 100 determines that the radio slave terminal 102 or the radio relay terminal 201 should perform the new participation operation for participating in the radio communication system, it commands the relay stage number analyzing section 1001 and the reception level measuring section 1002 to perform “new connection target deciding process”.

### [New Connection Target Deciding Process]

Next, a description will be given of the “new connection target deciding process” performed in the lower device such as the radio slave terminal or the radio relay terminal having the above described configuration, with reference to FIG. 22. For easier description, it is assumed that the radio slave terminal 302 of FIG. 1 performs the “new connection target deciding process”. FIG. 22 is a flowchart showing an exemplary new connection target deciding process performed in the lower device in the radio communication system according to Embodiment 2 of the present invention.

First of all, it is presupposed that that the radio slave terminal 302 is incorporated in the radio communication system and regularly receives the beacon signal from the upper device, i.e., the radio relay terminal 301. Also, it is presupposed that the above stated reception level A is stored and preserved in the reception level storage section 1005.

Initially, the radio slave terminal 302 regularly receives the beacon signal from the radio relay terminal 301, and the reception level measuring section 1002 measures the reception level B (step S31). The reception level measuring section 1002 notifies the reception level comparator section 1004 of the measured reception level B.

The reception level comparator section 1004 determines whether or not the reception level B measured in step S31 satisfies a relationship of B<(reception level A−specified level C) (step S32).

If the reception level comparator section 1004 determines that the reception level B does not satisfy the relationship of B<(reception level A−specified level C) in step S32 (“NO” in step S32), it resets the value stored in register X to zero (step S33), and the process returns to step S31. Then, the reception level comparator section 1004 commands the reception level measuring section 1002 to receive the beacon signal regularly transmitted.

Again, step S31 and step S32 are repeated, and if the reception level comparator section 1004 determines that the reception level B satisfies the relationship of B<(reception level A−specified level C), it increments the value in the register X by one (step S34).

After the value of the register is incremented in this way, the new participation determiner section 1006 determines whether or not the register X satisfies a relationship of X>specified value Y (step S35). The specified value Y is the number of times the reception level of the beacon signal satisfying the relationship of B<(reception level A−specified level C) has occurred, and is suitably set. In Embodiment 2, Y is set to 4.

The new participation determiner section 1006 determines that the register X does not satisfy the relationship of X>specified value Y in step S35, the process returns to step S31.

On the other hand, if the new participation determiner section 1006 determines that the register X satisfies the relationship of X>specified value Y in step S35, it decides to perform the new participation operation (step S36). That is, the new participation determiner section 1006 is configured not to decide to perform the new participation operation until the value of the register X exceeds the specified value Y. When the new participation determiner section 1006 decides to perform the new participation operation, it commands the relay stage number analyzing section 1001 and the reception level measuring section 1002 to newly perform “new connection target deciding process”.

Thus, by the operation described above, the lower device such as the radio slave terminal 302 receives the beacon signal regularly transmitted from the upper device for itself and performs the new participation operation if the reception level B has become B<(A−C) the specified number of times Y in succession. The new participation operation refers to an operation for deciding the radio master terminal or the radio relay terminal to which the lower device is subordinated, like a case where the power supply is ON again.

As described above, the radio terminal (e.g., radio slave terminal) according to Embodiment 2 determines that there has been a significant situation change, for example, a building is built, after the participation operation was performed, if the reception level B has become B<(A−C) the specified number of times (Y times) in succession, during the regular reception of the beacon signal. Then, the radio terminal starts to newly perform the new participation operation to select the radio terminal which is a new connection target. Although a criterion used for deciding to start to perform the new participation operation is the number of times the reception level B has become a value which is lowered from the reception level A by the specified level C or more, the present invention is not limited to this. For example, the criterion for deciding to start to perform the new participation operation may be such that a median reception level value of the reception levels B of the beacon signals received plural times has become equal to or lower than a specified value. In this case, the reception level measuring section 1002 measures the reception level B of the beacon signal regularly transmitted and the reception level storage section 1005 stores measurement data as history information of the reception level B. Then, the reception level comparator section 1004 finds the median reception level value from the history information of the reception levels B stored in the reception level storage section 1005. The new participation determiner section 1006 may be configured to decide to perform the new participation operation, if the median reception level value of the reception levels B derived for a specified period has become equal to or less than a specified value.

Nonetheless, the configuration in which it is decided to start to perform the new participation operation, according to the number of times the reception level B has become a value which is lowered from the reception level A by the specified level C or greater, like the radio terminal (lower device) of Embodiment 2 is more advantageous than the configuration in which it is decided to start to perform the new participation operation, depending on whether or not the median reception level value of the reception levels B has become equal to or less than the specified value, because processing is simpler in the former configuration than in the latter configuration.

Alternatively, if a ratio in which the reception level B of the beacon signal becomes equal to or lower than “reception level A−specified level C” within the specified period during the regular reception of the beacon signal, exceeds 0.3, the lower device may start the new participation operation to select the beacon signal of the radio terminal to which the lower device is to be newly subordinated. The ratio is defined as a ratio of the reception levels B which become equal to or lower than “reception level A−specified level C” with respect to the reception levels B of the beacon signals received within the specified time.

Specifically, if the ratio in which the reception level B of the beacon signal becomes equal to or lower than “reception level A−specified level C” within the specified period during the regular reception of the beacon signal, exceeds the specified value, for example, 0.3, the lower device determines that there has been a significant change in the situation, for example, a building has been built, after the participation operation was performed. Then, the lower device starts the new participation operation to select the upper device to which the lower device is to be newly connected. Even in a case where there is no significant change in the situation, for example, a building has been built, the reception level B might sometimes become equal to or lower than “reception level A−specified level C” within the specified period, due to the fading, etc. It should be noted that a probability with which the reception level B becomes equal to or lower than “reception level A−specified level C”, due to the fading, depends on a distribution of the fading. Of course, the probability with which the reception level B of the received beacon signal becomes equal to or lower than “reception level A−specified level C” in the case where the medium reception level value decreases due to the situation change, for example, a building is constructed, than in the case due to the fading.

As described above, the radio communication system according to Embodiment 2 is configured in such a manner that the lower device performs the new participation operation only when a state of electric waves surrounding the lower device changes and the reception level of the beacon signal received regularly from the upper device changes (is lowered) significantly by the specified level or more. Then, the lower device can newly select the radio terminal which is the connection target and change a route up to the radio master terminal. This makes it possible to avoid a situation in which all of the radio terminals regularly transmit electric (field) intensity measurement signals to another radio terminals, or receive all of the electric (field) intensity measurement signals transmitted from another radio terminals, in order to change the relay route, which situation occurs in the conventional system. In other words, since the number of times the signals are transmitted and received between the radio terminals to create the relay route does not increase, unlike the conventional technique, it becomes possible to prevent a problem that a traffic increases or a problem that electric power consumption increases.

### Modified Example, Typical Uses, Etc.

The above described Embodiment 1 and Embodiment 2 are applicable to general radio terminals or to general radio communication systems. Therefore, the specific configuration of the radio terminal and the specific configuration of the radio communication system are not limited to the above mentioned configurations, but are applicable to known radio terminals and known radio communication systems having various configurations.

Although in Embodiment 1 and Embodiment 2 three kinds of radio terminals, which are the radio master terminal, the radio relay terminal, and the radio slave terminal are used as the radio communication devices constituting the radio communication system, the present invention is not limited to this. The radio communication system may be composed of two kinds of radio terminals which are the radio master terminal and the radio slave terminal.

A communication operation performed by the radio master terminal, the radio relay terminal, and the radio slave terminal is implemented by programs for operating a computer and by cooperating with hard resources such as an electric device, an information device, and/or a computer. By storing these programs in a storage medium or distributing the programs using communication lines, the programs can be distributed, updated, installed, etc., in an easy manner.

Although in Embodiment 1 and Embodiment 2, the “slot position information” which is the slot number in which reception is awaited intermittently is used as the intermittent reception timing information contained in the route information, the present invention is not limited to this, and known other format information can be used so long as it can specify the intermittent reception timing (intermittent awaiting timing of reception), instead of the slot number.

In the radio terminal of Embodiment 1 and Embodiment 2, in a case where the connection target for the radio terminal which newly participates in the radio communication system is the radio master terminal, i.e., relay stage number which is contained in the beacon signal is zero, one condition for deciding the connection target is such that the reception level of this beacon signal is equal to or higher than the first specified value level. On the other hand, in a case where the connection target for the radio relay terminal which newly participates in the radio communication system is the radio relay terminal, i.e., the relay stage number contained in the beacon signal is a natural number greater than zero, one condition for deciding the connection target is such that the reception level of this beacon signal is equal to or higher than the second specified value level.

However, one condition for deciding the connection target for the radio terminal which newly participates in the radio communication system is not limited to this.

For example, in a case where the radio terminal which newly participates in the radio communication system is the radio slave terminal, one condition for deciding the connection target is such that the reception level of the received beacon signal is equal to or higher than the first specified value. By comparison, in a case where the radio terminal which newly participates in the radio communication system is the radio relay terminal, one condition for deciding the connection target may be such that the reception level of the received beacon signal is equal to or higher than the second specified value. In other words, the specified value corresponding to the reception level may be changed depending on whether the radio terminal which newly participates in the radio communication system is the radio slave terminal or the radio relay terminal.

In such a configuration, in the radio relay terminal which newly participates in the radio communication system, if the beacon signal in which the reception level is equal to or higher than the second specified value does not exist among the received beacon signals, the upper radio terminal deciding section 1003 may decide that there is no radio terminal which becomes the connection target.

In the radio terminal of Embodiment 2, the specified level C to be subtracted from the reception level A to derive the reception level B may be the fixed value or the variable value. In the case where the specified level C is the variable value, this variable value may be decided based on the reception level A set when the radio terminal which is the lower device newly participates in the radio communication network. In other words, in the case where the specified level C is the variable value, this variable value is decided at a time point when the radio terminal which is the lower device newly participates in the radio communication network. However, in the case where the specified level C is the variable value, the time point when this variable value is decided is not limited to the time point when the radio terminal which is the lower device newly participates in the radio communication network. For example, if the reception level of the received beacon signal changes greatly or frequently becomes below the reception level A, when a specified period passes after the radio terminal which is the lower device participates in the radio communication network, the value of the reception level A may be newly reviewed and changed. Then, the specified level C may be made variable according to the value of the changed reception level A.

Numeral modifications and alternative embodiments of the present invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention.

### INDUSTRIAL APPLICABILITY

As described above, the present invention is used suitably in fields of radio (wireless) communication systems such as a short-distance radio communication network, a mobile communication, a local area network, a transportation radio, a municipal disaster management network, wireless LAN, and radio meter reading systems for meters of gas, tap water, electric power, etc., and radio terminals for use in these systems.

### REFERENCE SIGNS LIST

1 antenna
2 transmission/reception section
3 beacon transmission section
4 link connection section
5 route information analyzing/creating section
6 timing information transmission section
7 control section
8 storage section
11 antenna
12 transmission/reception section
13 beacon transmission section
14 beacon reception section
15 link connection section
16 timing information analyzing section
17 control section
21 antenna
22 transmission/reception section
23 beacon reception section
24 link connection section
25 timing information transmission section
26 control section
27 storage section
32 link connection slot
35 link connection slot
40 base slot
41 lower slot
42 upper slot
50 link connection signal
51 repeated frame
58 bit synchronization signal
59 frame synchronization signal
60 control signal (relay stage number information)
62 beacon ID
87 route information
90 radio relay terminal information
91 slot position information
101 radio master terminal (radio terminal)
102 to 104 radio slave terminal (radio terminal)
201 radio relay terminal (radio terminal)
202 to 204 radio slave terminal (radio terminal)
301 radio relay terminal (radio terminal)
302 to 304 radio slave terminal (radio terminal)
401 radio relay terminal (radio terminal)
402 to 404 radio slave terminal (radio terminal)
501 radio relay terminal (radio terminal)
502 to 504 radio slave terminal (radio terminal)
601 radio relay terminal (radio terminal)
1001 relay stage number analyzing section
1002 reception level measuring section
1003 upper radio terminal deciding section
1004 reception level comparator section
1005 reception level storage section
1006 new participation determiner section

1. A radio communication system comprising:
a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal;
wherein the radio master terminal and the radio relay terminal are configured to transmit beacon signals each containing radio relay terminal number information which is information indicating the number of another radio relay terminals via which communication with the radio master terminal is performed;
wherein the radio terminal which newly participates in the radio communication system includes:
a measuring unit for measuring reception levels of the received beacon signals;
an information obtaining unit for obtaining the radio relay terminal number information from each of the received beacon signals; and
a deciding unit for deciding as a connection target a radio terminal which is a transmission source of the beacon signal in which the reception level measured by the measuring unit is determined as equal to or higher than a specified value, and the number of another radio relay terminals is smallest based on the radio relay terminal number information obtained by the information obtaining unit.

2. The radio communication system according to claim 1, wherein
the deciding unit decides as the connection target a radio terminal which is a transmission source of the beacon signal in which the reception level is highest, from among the beacon signals, when all of the reception levels of the beacon signals measured by the measuring unit are lower than the specified value.

3. The radio communication system according to claim 1, wherein
wherein the specified value includes a first specified value decided considering a noise level under a general environment in which the radio communication system is constructed and a second specified value set greater than the first specified value;
wherein the deciding unit determines whether or the reception level of the beacon signal is equal to or higher than the specified value by confirming whether or not the reception level of the beacon signal in which the number of another radio relay terminals is in a range of zero to a specified number or less is equal to or higher than the first specified value and confirming whether or not the reception level of the beacon signal in which the number of another radio relay terminals is greater than specified number is equal to or higher than the second specified value.

4. The radio communication system according to claim 1, wherein
wherein the specified value includes a first specified value decided considering a noise level under a general environment in which the radio communication system is constructed and a second specified value set greater than the first specified value;
wherein in a case where the radio terminal which newly participates in the radio communication system is the radio slave terminal, the deciding unit determines whether or not the reception level of the received beacon signal is equal to or higher than the first specified value; and
wherein in a case where the radio terminal which newly participates in the radio communication system is the radio relay terminal, the deciding unit determines whether or not the reception level of the received beacon signal is equal to or higher than the second specified value.

5. A radio communication system comprising:
a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal;
wherein the radio master terminal and the radio relay terminal are configured to transmit beacon signals each containing radio relay terminal number information which is information indicating the number of another radio relay terminals via which communication with the radio master terminal is performed;
wherein the radio terminal which newly participates in the radio communication system includes:
a measuring unit for measuring reception levels of the received beacon signals;
an information obtaining unit for obtaining the radio relay terminal number information from each of the beacon signals; and
a deciding unit for deciding the radio terminal as a connection target;
wherein the deciding unit decides the radio master terminal as the radio terminal which is the connection target when there exists the beacon signal in which the number of another radio relay terminals is zero based on the radio relay terminal number information obtained by the information obtaining unit, and the reception level measured by the measuring unit is equal to or higher than the specified value; and
when the number of another radio relay terminals is not zero, the deciding unit decides as the connection target the radio terminal which is a transmission source of the beacon signal in which the reception level measured by the measuring unit is equal to or higher than the specified value, and the number of another radio relay terminals is smallest based on the radio relay terminal number information obtained by the information obtaining unit.

6. A radio communication system comprising:
a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal;
wherein a beacon signal is regularly transmitted from the radio terminal which is an upper device to the radio terminal which is a lower device; and
wherein the radio terminal which is the lower device further includes:
a reception level determiner unit for determining whether or not a reception level B is equal to or lower than a value derived by subtracting a specified level C from a reception level A; and
a new connection target deciding unit for newly deciding as a connection target the radio terminal which is the upper device, when the reception level determiner unit determines that the reception level B is equal to or lower than the value derived by subtracting the specified level C from the reception level A,
the reception level A being a reception level of the beacon signal received from the radio terminal which is the upper device decided as the connection target by the radio terminal which is the lower device, when the radio terminal which is the lower device newly participates in the radio communication system,
the reception level B being a reception level of the beacon signal regularly received from the radio terminal which is the upper device, and
the specified level C being a value set in a range within which a decrease in the reception level from the reception level A is allowed.

7. The radio communication system according to claim 6,
wherein when it is determined that the reception level B of the beacon signal regularly received has become equal to or lower than the value derived by subtracting the specified level C from the reception level A a specified number of times in succession, the new connection target deciding unit newly decides as the connection target the radio terminal which is the upper device.

8. The radio communication system according to claim 6,
wherein when a ratio in which the reception level B of the beacon signal regularly transmitted has become equal to or lower than the value derived by subtracting the specified level C from the reception level A, within a specified period, exceeds a specified value, the new connection target deciding unit newly decides the radio terminal as the connection target.

9. The radio communication system according to claim 6,
wherein the specified level C is a value set according to a value of the reception level A.

10-11. (canceled)

12. A method of controlling a radio terminal which newly participates in a radio communication system including:
a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal;
wherein the radio master terminal and the radio relay terminal are configured to transmit beacon signals each containing radio relay terminal number information which is information indicating the number of another radio relay terminals via which communication with the radio master terminal is performed, the method comprising the steps of:
measuring reception levels of the received beacon signals;
obtaining the radio relay terminal number information from each of the beacon signals; and
deciding as a connection target the radio terminal which is a transmission source of the beacon signal in which the measured reception level of the beacon signal is equal to or higher than a specified value, and the number of another radio relay terminals is smallest based on the obtained radio relay terminal number information.

13. A method of controlling a radio terminal which is incorporated in a radio communication system and serves as a lower device, the radio communication system including:
a plurality of radio terminals including a plurality of radio slave terminals which are lowermost radio terminals, a radio master terminal as an uppermost radio terminal which performs radio communication with the radio slave terminals, and a radio relay terminal which intervenes between the radio slave terminals and the radio master terminal, and relays radio communication between the radio slave terminals and the radio master terminal;
wherein in the radio terminal which is incorporated in the radio communication system, a beacon signal is regularly transmitted from the radio terminal which is an upper device to the radio terminal which is a lower device; the method comprising the steps of:
determining whether or not a reception level B is equal to or lower than a value derived by subtracting a specified level C from a reception level A; and
newly deciding as a connection target the radio terminal which is the upper device, when it is determined that the reception level B is equal to or lower than the value derived by subtracting the specified level C from the reception level A,
the reception level A being a reception level of the beacon signal received from the radio terminal which is the upper device decided as the connection target by the radio terminal which is the lower device, when the radio terminal which is the lower device newly participates in the radio communication system,
the reception level. B being a reception level of the beacon signal regularly received from the radio terminal which is the upper device, and
the specified level C being a value set in a range within which a decrease in the reception level from the reception level A is allowed.

14. (canceled)
